(19) United States
(12) Patent Application Publication
(10) Pub. No.: US 2026/0329457 A1
(43) Pub. Date: Oct. 22, 2026

(54) APPARATUS AND OPERATION METHOD FOR PROTECTING DATA IN A POOLED MEMORY SYSTEM

(71) Applicant: SK hynix Inc., Gyeonggi-do (KR)

(72) Inventors: Hui Jae YU, Gyeonggi-do (KR); Kyoung Ku CHO, Gyeonggi-do (KR); Jung Hyun JOH, Gyeonggi-do (KR)

(21) Appl. No.: 19/330,746

(22) Filed: Sep. 16, 2025

(30) Foreign Application Priority Data
Apr. 17, 2025 (KR) 10-2025-0049985

(51) Int. Cl. G06F 3/06

(52) U.S. Cl. CPC G06F 3/0622; G06F 3/0608; G06F 3/0659; G06F 3/067

(57) ABSTRACT

A memory system includes a memory device configured to store data input along with a data input and output (input/output) command or read the stored data; and a controller configured to receive the data input/output command from at least one of a plurality of external devices and output a response corresponding to the data input/output command, store, in the memory device, swap data transmitted from a first external device among the plurality of external devices, and head off a write operation corresponding to a write command which is input from a second external device among the plurality of external devices, along with a same logical address as the swap data.

### CROSS-REFERENCE TO RELATED APPLICATIONS

This patent application claims the benefit of Korean Patent Application No. 10-2025-0049985, filed on Apr. 17, 2025, the entire disclosure of which is incorporated herein by reference.

### TECHNICAL FIELD

One or more embodiments of the present disclosure described herein relates to a data storage device or a memory system, and more particularly, to an apparatus and an operating method for protecting data in a shared or pooled memory system.

### BACKGROUND

Data processing systems including memory systems or data storage devices are being developed to store more data in the data storage device, store data in the data storage device more quickly, and output data stored in the data storage device more quickly. These data processing systems may include a plurality of hosts and a plurality of data storage devices. The data storage devices may include non-volatile memory cells and/or volatile memory cells for storing data. Additionally, each memory cell may store multi-bit data.

### BRIEF DESCRIPTION OF THE DRAWINGS

The description herein makes reference to the accompanying drawings wherein like reference numerals refer to like parts throughout the figures.

FIG. 1 illustrates a data processing system according to an embodiment of the present disclosure.

FIG. 2 illustrates a configuration of a host and a memory system according to an embodiment of the present disclosure.

FIG. 3 illustrates a swap operation according to an embodiment of the present disclosure.

FIG. 4 illustrates a swap operation of a data processing system according to an embodiment of the present disclosure.

FIG. 5 illustrates a method for protecting swap data according to an embodiment of the present disclosure.

FIG. 6 illustrates an operation method of a data processing system according to an embodiment of the present disclosure.

FIG. 7 illustrates a data processing system in which swap data is not protected.

FIG. 8 illustrates an operation method of a data processing system according to an embodiment of the present disclosure.

FIG. 9 illustrates an operation method of a memory system according to an embodiment of the present disclosure.

FIG. 10 illustrates a write command according to an embodiment of the present disclosure.

FIG. 11 illustrates map data of a memory system according to an embodiment of the present disclosure.

FIG. 12 illustrates a first operation of a shared memory device according to an embodiment of the present disclosure.

FIG. 13 illustrates a second operation of a shared memory device according to an embodiment of the present disclosure.

FIG. 14 illustrates a data processing system according to an embodiment of the present disclosure.

FIG. 15 illustrates a memory system according to an embodiment of the present disclosure.

### DETAILED DESCRIPTION

Various embodiments of the present disclosure are described below with reference to the accompanying drawings. Elements and features of this disclosure may be configured or arranged differently to form other embodiments, which may be variations of any of the disclosed embodiments.

In this disclosure, references to various features (e.g., elements, structures, modules, components, steps, operations, characteristics, etc.) included in “one embodiment,” “example embodiment,” “an embodiment,” “another embodiment,” “some embodiments,” “various embodiments,” “other embodiments,” “alternative embodiment,” and the like are intended to mean that any such features are included in one or more embodiments of the present disclosure, but may or may not necessarily be combined in the same embodiments.

In this disclosure, the terms “comprise,” “comprising,” “include,” and “including” are open-ended. As used in the appended claims, these terms specify the presence of the stated elements and do not preclude the presence or addition of one or more other elements. Furthermore, the terms in a claim do not foreclose the apparatus from including additional components, e.g., an interface unit, circuitry, etc.

In this disclosure, various units, circuits, or other components may be described or claimed as “configured to” perform a task or tasks. In such contexts, “configured to” is used to connote structure by indicating that the blocks/units/circuits/components include structure (e.g., circuitry) that performs one or more tasks during operation. As such, the block/unit/circuit/component can be said to be configured to perform the task even when the specified block/unit/circuit/component is not currently operational, e.g., is not turned on nor activated. The block/unit/circuit/component used with the “configured to” language include hardware, for example, circuits, memory storing program instructions executable to implement the operation, etc. Additionally, “configured to” can include a generic structure (e.g., generic circuitry) that is manipulated by software and/or firmware (e.g., an FPGA or a general-purpose processor executing software) to operate in manner that is capable of performing the task(s) at issue. “Configured to” may also include adapting a manufacturing process (e.g., a semiconductor fabrication facility) to fabricate devices (e.g., integrated circuits) that are adapted to implement or perform one or more tasks.

As used in this disclosure, the term ‘circuitry’ or ‘logic’ refers to all of the following: (a) hardware-only circuit implementations (such as implementations in only analog and/or digital circuitry) and (b) combinations of circuits and software (and/or firmware), such as (as applicable): (i) to a combination of processor(s) or (ii) to portions of processor(s)/software (including digital signal processor(s)), software, and memory(ies) that work together to cause an apparatus, such as a mobile phone or server, to perform various functions and (c) circuits, such as a microprocessor(s) or a portion of a microprocessor(s), that require software or firmware for operation, even if the software or firmware is not physically present. This definition of ‘circuitry’ or ‘logic’ applies to all uses of this term in this application, including in any claims. As a further example, as used in this application, the term “circuitry” or “logic” also covers an implementation of merely a processor (or multiple processors) or portion of a processor and its (or their) accompanying software and/or firmware. The term “circuitry” or “logic” also covers, for example, and if applicable to a particular claim element, an integrated circuit for a storage device.

As used herein, the terms “first,” “second,” “third,” and so on are used as labels for nouns that they precede, and do not imply any type of ordering (e.g., spatial, temporal, logical, etc.). The terms “first” and “second” do not necessarily imply that the first value must be written before the second value. Further, although the terms may be used herein to identify various elements, these elements are not limited by these terms. These terms are used to distinguish one element from another element that otherwise have the same or similar names. For example, a first circuitry may be distinguished from a second circuitry.

Further, the term “based on” is used to describe one or more factors that affect a determination. This term does not foreclose additional factors that may affect a determination. That is, a determination may be solely based on those factors or based, at least in part, on those factors. Consider the phrase “determine A based on B.” While in this case, B is a factor that affects the determination of A, such a phrase does not foreclose the determination of A from also being based on C. In other instances, A may be determined based solely on B.

Herein, a data entry, an entry of data, an item of data, or a data item may be a sequence of bits. For example, the data entry may include the contents of a file, a portion of the file, a page in memory, an object in an object-oriented program, a digital message, a digital scanned image, a part of a video or audio signal, metadata or any other entity which can be represented by a sequence of bits. According to an embodiment, the data entry may include a discrete object. According to another embodiment, the data entry may include a unit of information processed or handled for a data input/output operation. According to another embodiment, the data entry may include a unit of information within a transmission packet between two different components.

Embodiments of the present disclosure can provide a memory device, a memory system including the memory device, a controller included in the memory system, or a data processing device including the memory system.

Embodiments of the present disclosure can provide an apparatus and a method capable of protecting swap data transmitted from a specific host to a memory system under an operating environment where plural hosts can access the memory system.

A memory system according to an embodiment of the present disclosure can provide an apparatus and a method capable of receiving an identifier for swap data from a host, inserting information for protecting the swap data into map data for the swap data stored in a memory device, and determining whether to perform a data input/output command based on the map data when the data input/output command for the same logical address as the swap data is received.

One embodiment of the present disclosure can provide an apparatus and a method capable of storing swap data requested by a specific host in a memory device or memory system that can be shared and used by plural hosts, and stopping, heading off, or blocking a write operation when a host other than the corresponding host among the plural hosts requests the corresponding write operation that changes the swap data.

In an embodiment, a memory system can include a memory device configured to store data input along with a data input and output (input/output) command or read the stored data; and a controller configured to receive the data input/output command from at least one of a plurality of external devices and output a response corresponding to the data input/output command, store, in the memory device, swap data transmitted from a first external device among the plurality of external devices, and head off a write operation corresponding to a write command which is input from a second external device among the plurality of external devices, along with a same logical address as the swap data.

The controller may be configured to receive, from the first external device, a write command with a swap identifier for storing the swap data in the memory device.

The controller may be configured to: generate a map data entry for a logical address and a physical address or a virtual address of the swap data; and add, to the map data entry, a protection identifier indicating that data associated with the map data entry belongs to a protected area in the memory device.

The controller may be configured to: perform a garbage collection or a read reclaim operation on the memory device; and maintain the protection identifier in the map data entry, after the garbage collection or the read reclaim operation performs the data belongs to the protected area and updates the map data entry associated with the data.

The controller may be configured to: include an error code in a response corresponding to a write command input along with the same logical address from the first external device; and transmit the response to the first external device.

The controller may be configured to transmit the swap data to the first external device when a read command transmitted from the first external device is input along with the same logical address.

The controller may be configured to: include a restriction code in a response corresponding to the write command input along with the same logical address from the second external device; and transmit the response to the second external device.

The controller may be configured to delete a map data entry for the swap data based on a swap release command input along with the same logical address from the first external device.

The controller may be configured to: include an error code in a response corresponding to a swap release command input along with the same logical address from the second external device; and transmit the response to the second external device.

The memory device may include a data storage area configured to store write data transmitted from the plurality of external devices; and a swap area configured to store the swap data that is distinct from the write data. The controller can be configured to: partition the data storage area and the swap area into different logical areas; and generate different map data for the data storage area and the swap area.

The memory device may include a plurality of volatile memory cells or a plurality of nonvolatile memory cells configured to store the swap data.

In another embodiment, a data processing system may include at least one host, comprising at least one application and a file system, configured to determine a location where write data generated by the at least one application is stored based on the file system; and at least one memory system configured to receive swap data from the at least one host, generate a map data entry for the swap data and determine whether to access the swap data based on the map data entry.

The map data entry may include a logical address of the swap data and a protection identifier indicating access authority to the logical address.

The protection identifier may include at least one of an identifier indicating whether associated data is the swap data; and unique information assigned to the at least one host which has the access authority.

The at least one host may be configured to be rebooted when a range of logical addresses used by the at least one host is changed. The at least one memory system can be configured to: receive a changed range of logical addresses used by the at least one host after reboot of the at least one host; and apply the changed range to map data including the map data entry.

The at least one host may be configured to transmit, to the at least one memory system, a write command including a swap identifier set to store the swap data in the at least one memory system.

The at least one memory system may include a memory device configured to store data corresponding to a data input and output (input/output) command input from the at least one host or read the stored data; and a controller configured to receive the data input/output command and output a response to the data input/output command.

The controller may be configured to: store, in the memory device, the swap data transmitted from a first host among the at least one host; and head off a write operation corresponding to a write command when the write command is input, from a second host among the at least one host, along with a same logical address as the swap data.

The controller may be configured to: include an error code in a response to a write command input along with the same logical address from the first host; and transmit the response to the first host.

The controller may be configured to transmit the swap data to the first host based on a read command transmitted along with the same logical address from the first host.

The controller may be configured to: include a restriction code in a response corresponding to a read command input along with the same logical address from the second host; and transmit the response to the second host.

The controller may be configured to delete a map data entry for the swap data based on a swap release command input along with the same logical address from the first host.

The controller may be configured to: include an error code in a response corresponding to a swap release command input along with the same logical address from the second host; and transmit the response to the second host.

In another embodiment, a data processing system may include at least one host comprising a plurality of virtual machines individually configured to perform data communication with an input and output (input/output) device through different address ranges in a unified logical address scheme; and at least one memory system, as the input/output device, configured to store swap data transmitted from the at least one host. The at least one host can be configured to set a logical address of the swap data, in the unified logical address scheme, to be unavailable to the plurality of virtual machines.

In the data processing system, at least one of the plurality of virtual machines can execute at least one application configured to generate the swap data or designate write data as the swap data.

The at least one memory system can include a remote storage space coupled to the at least one host via a network.

The at least one host can be configured to: add an identifier indicating the swap data to a write command; and transmit the write command to the at least one memory system.

An embodiment described herein can provide an apparatus and a method for improving a data input/output operation of a memory system or a data processing system. Embodiments will now be described with reference to the accompanying drawings, wherein like numbers reference like elements.

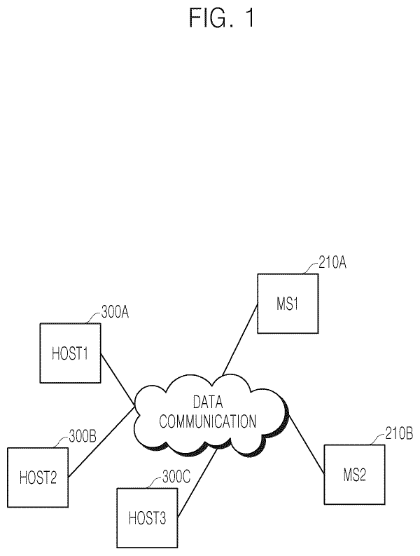

FIG. 1 illustrates a data processing system according to an embodiment of the present disclosure.

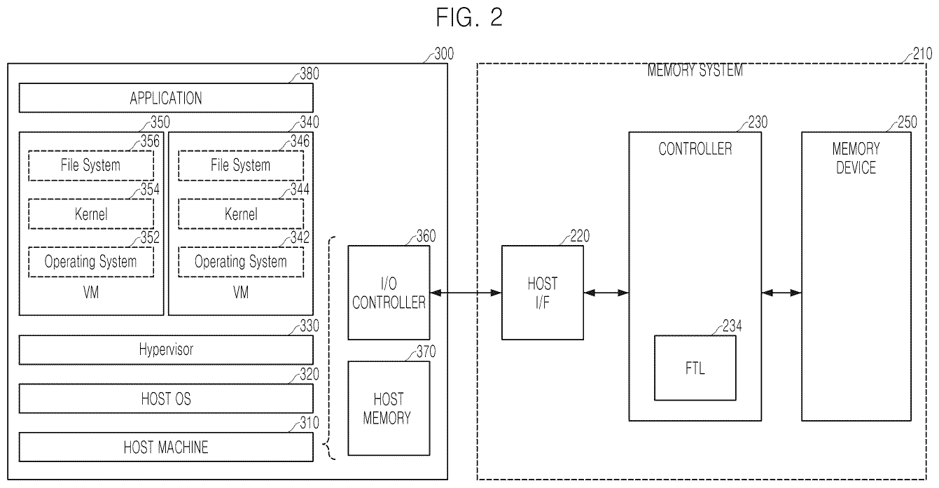

Referring to FIG. 1, the data processing system may include a plurality of hosts (e.g., host 1 to host 3) 300A, 300B, 300C and a plurality of memory systems (e.g., MS1 to MS2) 210A, 210B. The plurality of hosts 300A, 300B, 300C and the plurality of memory systems 210A, 210B may perform data communication in a preset manner. According to an embodiment, the plurality of hosts 300A, 300B, 300C and the plurality of memory systems 210A, 210B can support not only 1:1 data communication but also 1:N data communication (N is a natural number greater than or equal to 2). The internal configuration of the plurality of hosts 300A, 300B, 300C and the plurality of memory systems 210A, 210B will be described below with reference to FIG. 2.

According to an embodiment, the plurality of memory systems 210A, 210B can constitute a data infrastructure. Here, the data infrastructure refers to a digital infrastructure that facilitates data sharing and consumption. Like other infrastructures, the data infrastructure can include structures, services, and facilities necessary for data sharing and consumption. For example, the data infrastructure can include various components including hardware, software, networking, services, policies, etc., that enable data consumption, storage, and sharing. The data infrastructure may provide or support a foundation for generating, managing, using, and protecting data.

For example, the data infrastructure may be divided into physical infrastructure, information infrastructure, and business infrastructure. The physical infrastructure may include data storage devices, data processing devices, input/output networks, data sensor facilities, etc. The information infrastructure may include cloud resources and services, including business applications, data repositories such as databases and data warehouses, virtualization systems, and virtual services. The business infrastructure may include a business intelligence (BI) system and an analytics-tool systems such as big data, artificial intelligence (AI), and machine learning (ML).

According to an embodiment, the plurality of hosts 300A, 300B, 300C and the plurality of memory systems 210A, 210B may perform data communication through a Compute Express Link (CXL)-based interface or a CXL-based protocol that supports memory pooling and memory sharing. The memory pooling may allow the plurality of hosts 300A, 300B, 300C in a heterogeneous topology to access a common memory address range. Each host can be assigned a non-overlapping address range from a pool of memory resources. Through the memory pooling, data infrastructure or data processing devices may dynamically allocate memory within a pool, thereby reducing wasted memory and increasing memory utilization. CXL-based interfaces or CXL-based protocols can provide effects such as efficient memory allocation, guaranteed memory access, memory isolation between plural hosts or processors, and data or system security.

Meanwhile, the memory sharing can allow the plurality of hosts 300A, 300B, 300C in a heterogeneous topology to access a common memory address range, and each host and other hosts can be assigned a same address range. Because the plurality of hosts 300A, 300B, 300C can access the same data, data flow could be performed efficiently, but data infrastructure or data processing devices should manage coherency between hosts to avoid or prevent data from being incorrectly overwritten by other hosts. CXL-based interfaces or CXL-based protocols can provide efficient data communication between plural hosts or processors, low latency, and reduced power consumption.

FIG. 2 illustrates a configuration of a host and a memory system according to an embodiment of the present disclosure.

Referring to FIG. 2, a host 300 can perform data communication with a memory system 210. A plurality of virtual machines (VMs) 340, 350 can be operated on or within the host 300.

The host 300 can include at least one application 380. The application 380 can be executed on the host operating system 320 and can also be executed through the plurality of virtual machines 340, 350. According to an embodiment, the application 380 can include a software program that a user uses to perform a specific task. The application 380 may perform multiple tasks and generate data according to the performed tasks. The data that relates to data preservation generated and requested by the application 380 can be transferred to and stored in the memory system 210.

The host 300 can include a host machine 310 and a host operating system 320 on or within which the plurality of virtual machines (VMs) 340, 350 can be operated. The host machine 310 may include a physical computing device on which a virtual machine is executed. For example, the host machine 310 may include plural hardware-related components (e.g., processor, memory, storage device, etc.). The host machine 310 may have the ability to run the plurality of virtual machines 340, 350 simultaneously, and may allocate resources to the plurality of virtual machines 340, 350 through virtualization software (e.g., a hypervisor 330).

A host operating system (OS) 320 may include an operating system running on the host machine 310. The host operating system 320 may directly interact with the host machine 310, which is physical hardware, and may provide an environment in which the hypervisor 330 could be installed. The host operating system 320 may manage the plurality of virtual machines 340, 350 and allocate resources required by the plurality of virtual machines 340, 350.

The hypervisor 330 may act as an interface between the host machine 310, which is physical hardware, and the plurality of virtual machines 340, 350. The embodiment according to the present disclosure may be implemented with two main types of hypervisors 330. A type 1 hypervisor (e.g., VMware ESXi, Microsoft Hyper-V) can run directly on the host machine 310, which is a physical hardware, and can manage the plurality of virtual machines 340, 350. On the other hand, a type 2 hypervisor (e.g., VMware Workstation, Oracle VirtualBox) can run on the host operating system 320 and can support the plurality of virtual machines 340, 350 on the host operating system 320.

The plurality of virtual machines 340, 350 may be associated with an independent computer environment provided through virtualizing the hardware of the host machine 310. Each of the plurality of virtual machines 340, 350 may run its own operating system 342, 352 and run applications on its own operating system 342, 352. The plurality of virtual machines 340, 350 may share resources of the host machine 310, but operate independently of each other. Therefore, an issue or a problem occurring in the first virtual machine 340 may not affect the second virtual machine 350.

Each of the plurality of virtual machines 340, 350 may include an operating system 342, 352, a kernel 344, 354, and a file system 346, 356. The operating system 342, 352 within the plurality of virtual machine 340, 350 may include software that enables the virtual machine (340, 350) to operate independently. The operating system 342, 352 can play a role in allowing a user to execute an application, managing hardware resources, and handling interactions between a user and the host system 300. The operating system 342, 352 within the plurality of virtual machines 340, 350 does not directly use the hardware of the host machine 310, but uses virtualized resources through the hypervisor 330. Therefore, the operating system 342, 352 within the plurality of virtual machines 340, 350 may operate independently from the host operating system 320.

The kernel 344, 354 may manage or control the interaction between hardware and software. The kernel 344, 354 may perform a basic system function such as memory management, process management, and device management. According to an embodiment, the kernel 344, 354 can be viewed as a component of the operating system 342, 352. The kernel 344, 354 within the plurality of virtual machines 340, 350 can manage virtualized hardware resources and can allocate resources requested by the plurality of virtual machines 340, 350. The kernel 344, 354 can have a significant impact on the performance and stability of the plurality of virtual machines 340, 350.

The file system 346, 356 may include software that defines how to store and manage data. The file system 346, 356 may enable operations such as creating, deleting, reading, and writing files and directories. The file system 346, 356 in the plurality of virtual machines 340, 350 can be stored in a virtual disk image file, which can be located in a physical storage device (e.g., host memory) through the host machine 310. The plurality of virtual machines 340, 350 can manage data and enable applications to access necessary files, through the file system 346, 356.

According to an embodiment, the plurality of virtual machines 340, 350 can be configured as a container. The container may perform functions that the plurality of virtual machines 340, 350 can perform, but have a structural difference from the plurality of virtual machines 340, 350. The biggest difference between the plurality of virtual machines 340, 350 and the container may be the presence or absence of a kernel. The plurality of virtual machines 340, 350 may include a separate kernel 344, 354 distinct from the host machine 310 and the host operating system 320, while the container uses a kernel included in the host operating system 320.

The kernel 344, 354 may include the lowest level operating system software that interfaces with the computing device. The kernel 344, 354 may act as an intermediary between application executables running on the host 300, such as the computing device, and the operating system 342, 352 and the host machine 310. The host machine 310 can be interacted with so that processes, called services and servers, can obtain information from each other using inter-process communication (IPC). The kernel 344, 354 may handle disk I/O operations, network traffic, and storage. Because the plurality of virtual machines 340, 350 can include a separate kernel 344, 354 rather than using the kernel of the host operating system 320, the plurality of virtual machines 340, 350 can run an operating system 342, 353 different from the host operating system 320. Additionally, the plurality of virtual machines 340, 350 can include their own virtual file systems 346, 356 which are separate from the host machine 310 and the host operating system 320, whereas a container may use a file system that interfaces with the host machine 310 and the host operating system 320.

Referring to FIG. 2, the memory system 210 may include a memory device 250 including non-volatile memory cells, and the host 300 can include a file system for storing and managing data in the non-volatile memory device. For example, the host 300 may include a Flash-Friendly File System (F2FS), which is a file system designed for a flash memory-based storage device. The F2FS can be designed considering the characteristics of the flash memory. Unlike volatile memories such as static random access memory (SRAM) and dynamic random access memory (DRAM), a flash memory may have limited write and delete operations. The F2FS may efficiently manage program and erasure of data by reflecting the characteristics of the flash memory.

The F2FS is a log-structured file system (LFS) that can improve the writing performance by continuously recording data and metadata. In particular, the F2FS may maximize the performance by utilizing the page-based writing method of the flash memory. The log-structured file system (LFS) is designed to record data in the form of a log, so that changes to all files can be sequentially recorded in the log. This method may minimize random access of the memory system 210 and improve performance through continuous writing. Unlike other file systems, the log-structured file system (LFS) may operate by adding data to a new location when storing data in the memory system 210, so that it may support the memory system 210 to perform a write operation quickly when considering the characteristics of the flash memory that has a limitation in overwriting.

The F2FS may (be configured to) help extend a life of the flash memory included in the memory system 210 by periodically organizing unused blocks through garbage collection and efficiently managing storage space through this operation. When unused blocks occur as data recorded in the log accumulates, the log-structured file system (LFS) may organize the unused blocks through the garbage collection and secure a space or an area for writing new data or other data. For example, the F2FS may support operations such as the slack space recycling for the garbage collection or partial garbage collection.

The F2FS is a log-structured file system (LFS), which has a log structure. Even if the memory system 210 is suddenly stopped, it could easily recover to the last recorded status through the stored log. Therefore, the log-structured file system (LFS) may improve data integrity. According to an embodiment, the log-structured file system (LFS) such as F2FS can be integrated into a Linux kernel and used on a mobile platform such as an android operating system.

The log-structured file system (LFS) may have many advantages over other file systems, mainly in an operating environment where write operations are frequently performed, and may be used in a database system or a high-performance server. Because the log-structured file system (LFS) records the data of the file system in a form of the log, it may be able to perform operations to improve write performance and reduce disk fragmentation. For example, the log-structured file system (LFS) may perform operations such as LFS cleaning, hole-plugging, and slack space recycling to increase efficiency and optimize a storage space.

Referring to FIG. 2, the memory system 210 may include a memory device 250. The host 300 can utilize the memory device 250, including non-volatile memory cells, included in the memory system 210 to store data and retrieve stored data. For example, the memory device 250 can include at least one of all types of non-volatile memory such as Magnetic RAM (MRAM), NAND, NOR, and hard disk drive (HDD). In the following description, the memory device 250 is described as a non-volatile memory (NVM) for simplification and illustration purposes.

Meanwhile, the host 300 may include a host memory 370. According to an embodiment, the host memory 370 may be one of the components or elements included in the host machine 310. The application 380, the host operating system 320, and the virtual machine 340, 350 may generate necessary data and store the generated data in the host memory 370 to use the generated data later. For example, the host memory 370 may include a main memory, an operating memory, a buffer memory, or a cache memory included in the host 300. The host memory 370 may include a volatile memory such as DRAM or SRAM.

The host memory 370 may be accessed by the host machine 310 through a memory access interface. For example, the host central processing unit (CPU) may directly access a physical address through a memory controller in the host machine 310 and may quickly access it with instructions such as load/store (e.g., MOV, LDR, STR, etc.). In addition, the host machine 310 may directly access the host memory 370 in byte units. According to an embodiment, in the case of the virtual machine 340, 350, a virtual memory address translation can be performed through a memory management unit (MMU) to access the host memory 370.

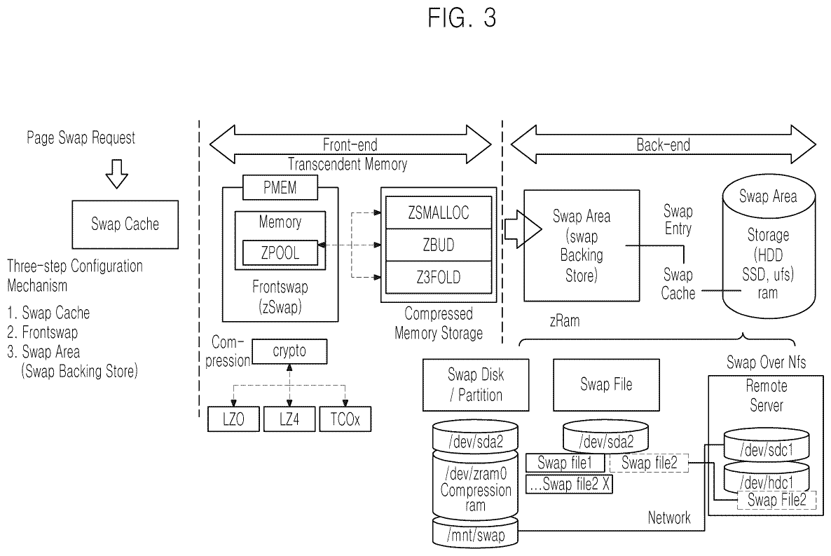

The host memory 370 may be set to quickly respond to requests from the application 380, the host operating system 320, and the virtual machine 340, 350. In addition, as the operations of the application 380, the host operating system 320, and the virtual machines 340, 350 become more complex, the size of data that the application 380, the host operating system 320, and the virtual machines 340, 350 require to be stored in the host memory 370 may also increase. If the host memory 370 has difficulty storing the data that the application 380, the host operating system 320, and the virtual machines 340, 350 require, the host 300 may perform a swap operation and use the memory system 210 as a swap memory. The swap memory may refer to a spawn space that may replace the insufficient storage space by using a space of a storage device such as the memory system 210 when the host memory 370 is full but more storage space is required. The swap operation will be described later with reference to FIGS. 3 to 11.

According to an embodiment, the host 300 may include an input/output (I/O) controller 360. The input/output controller 360 is a hardware device that handles communication between a CPU or processor included in the host machine 310 and various input/output (I/O) devices connected or interlocked with the host 300, and performs functions of controlling and adjusting the timing of the input/output (I/O) devices and exchanging data with the host machine 310. The input/output (I/O) devices may include a memory system 210.

In some instances, the input/output (I/O) devices may not be directly connected to the host machine 310 through a system bus within the host 300 because the types of input/output (I/O) devices are diverse and the methods of controlling their operation are different. Because it is inefficient for the host machine 310 to include plural circuits for controlling the input/output (I/O) devices, the input/output controller 360 may be used or included. In addition, because the operating speed of the host machine 310 and the operating speed of the input/output (I/O) device are different, the input/output controller 360 may perform the function of a relay. In addition, because the size and length of data exchanged between the host machine 310 and the input/output I/O device for data communication can be different, the input/output controller 360 may perform an interface function.

According to an embodiment, the input/output controller 360 may adjust the timing of control and communication of the input/output (I/O) device, perform communication with the host machine 310 and the input/output (I/O) device, perform a data buffering function, or detect an error in the transmitted data. Examples of input/output controllers 360 can include an I/O Controller Hub (ICH) used to manage data communication between a central processing unit and a main board, a universal serial bus (USB) host controller that performs communication between a USB device and a host, a PCI Express (PCIe) host controller that performs communication between a PCIe device and a host, and a SATA host controller that performs communication between a serial advanced technology attachment (SATA) device and a host.

Referring to FIG. 1 and FIG. 2, the data processing device may include a plurality of storage devices, such as the memory system 210. For example, the data processing device may include a plurality of memory systems 210 configured as a redundant array of independent disks (RAID) that function together as mass storage devices for the host 300. Also, according to an embodiment, the data processing device may include a plurality of computing devices, such as the host 300. For example, the data processing device may include the memory system 210 configured as a shared memory device so that the plurality of computing devices, such as the host 300, can use the memory system for data storage and retrieval.

The data processing device can include the host 300 that is capable of storing and/or retrieving data in one or more storage devices (e.g., the memory system 210). As illustrated in FIG. 1, the host 300 may perform data communication with the memory system 210 via a host interface (I/F) 220. The host 300 can include a wide range of devices, including mobility electronics such as automotive, electronic devices such as cell phones or MP3 players, computer servers, network attached storage (NAS) devices, desktop computers, notebook (i.e., laptop) computers, tablet computers, set-top boxes, telephones such as “smart” phones, “smart” pads, televisions, cameras, display devices, digital media players, video game consoles, video streaming devices, and the like.

The memory system 210 may include a controller 230, the memory device 250, and the host interface 220. The controller 230 can include a flash translation layer (FTL) 234. The flash translation layer (FTL) 234 can translate a logical address into a physical address for supporting data input/output operations. The flash translation layer (FTL) 234 can generate map data (e.g., L2P, P2L). Depending on an operating state, the flash translation layer (FTL) 234 can control or perform an operation for garbage collection, read retry, wear leveling, and the like. The controller 230 and the flash translation layer (FTL) 234 can use at least one memory included in, engaged with, or linked to, the controller 230. For example, the at least one memory can include a static random access memory (SRAM) and a dynamic random access memory (DRAM).

According to an embodiment, the memory system 210 can include additional components not shown in FIG. 2 for clarity. For example, the memory system 210 may include a printed circuit board (PCB) including electrically conductive wiring, etc., to which components of the memory system 210 are mechanically attached and electrically interconnecting components of the memory system 210. In some examples, the physical dimensions and connector configurations of the memory system 210 may conform to one or more standard form factors. For example, standard form factors may include, but are not limited to, 2.5-inch data storage devices (e.g., HDD or solid state drive (SSD)), 1.8-inch data storage devices, peripheral component interconnect (PCI), PCI expansion (PCI-X), and PCI Express (PCIe) (e.g., PCIe x1, x4, x8, x16, PCIe Mini Card, MiniPCI, etc.). According to an embodiment, the memory system 210 can be directly connected (e.g., directly soldered) to a motherboard of the host 300.

The host interface 220 of the memory system 210 may include one or both of a data bus for exchanging data with the host 300 and a control bus for exchanging commands with the host 300. The host interface 220 may operate according to any suitable protocol. For example, the host interface 220 may operate according to one or more of advanced technology attachment (ATA) (e.g., serial ATA (SATA) and parallel ATA (PATA)), universal serial bus (USB), multi-media card (MMC), fiber channel protocol (FCP), small computer system interface (SCSI), serial attached SCSI (SAS), serial advanced technology attachment (SATA), mobile industry processor interface (MIPI), PCI, PCIe, non-volatile memory express (NVMe), OpenCAPI, GenZ, Cache Coherent Interface Accelerator (CCIX), Compute Express Link (CXL), open channel solid state drive (Open Channel SSD, OCSSD), or similar protocols. An electrical connection (e.g., a data bus, a control bus, or both) of the host interface 220 can be electrically connected to the controller 230 to provide an electrical connection between the host 300 and the controller 230 to exchange data between the host 300 and the controller 230. According to an embodiment, the electrical connection of the host interface 220 may allow the memory system 210 to receive power from the host 300. For example, a power supply related device of the memory system 210 can receive power from the host 300 via the host interface 220.

The memory system 210 may include a memory device 250 including a plurality of data storage areas. According to an embodiment, the memory device 250 may be configured to store and/or retrieve data. For example, a memory die or memory chip included in the memory device 250 may receive data from the controller 230 and a message or a command instructing the memory device to store the data. Similarly, a memory die or memory chip included in the memory device 250 may receive a message instructing the memory device to retrieve the data from the controller 230. According to an embodiment, a memory die or memory chip included in the memory device 250 may be configured to store a relatively large amount of data (e.g., 128 MB, 256 MB, 412 MB, 1 GB, 2 GB, 3 GB, 8 GB, 16 GB, 22 GB, 54 GB, 128 GB, 256 GB, 412 GB, 1 TB, etc.).

According to an embodiment, the memory device 250 may include any type of non-volatile memory device, such as a Read Only Memory (ROM), a Mask ROM (MROM), a Programmable ROM (PROM), an Erasable ROM (EPROM), an Electrically Erasable ROM (EEPROM), a Phase change RAM (PRAM), a Magnetic RAM (MRAM), a NAND or NOR flash memory, a Phase Change Random Access Memory (PCRAM), a Resistive Random Access Memory (RRAM), a Ferroelectric Random Access Memory (FRAM), a Spin Transfer Torque Magnetic Random Access Memory (STT-MRAM), a holographic memory device, a hard disk drive (HDD), and any other type of nonvolatile memory device.

According to an embodiment, the memory device 250 may include a plurality of flash memory devices. The flash memory device may include a NAND or NOR based flash memory device, and may store data based on an amount of charge contained in a floating gate of the transistor for each flash memory cell. In the NAND flash memory device, the flash memory device may be divided into a plurality of blocks, and the blocks can be divided into a plurality of pages. Each block of the plurality of blocks within a particular memory device may include a plurality of NAND cells. Rows of NAND cells can be electrically connected using word lines to establish the plurality of pages. Each cell in each of the plurality of pages can be electrically connected to a respective bit line. Additionally, the NAND flash memory device can be a 2D or 3D device. The flash memory device may include single level cells (SLC), multi-level cells (MLC), triple level cells (TLC), quad level cells (QLC), or higher level cells. The controller 230 may write and read data to and from the NAND flash memory device at the page level, and may erase data stored in the NAND flash memory device at the block level.

A portion of the memory device 250 may be formatted as a logical block, zone, or area such that a storage capacity of the memory device 250 is divided into multiple streams. Each stream may include plural physical blocks or plural erase blocks of the memory device 250. Each physical block may be associated with plural logical blocks. Each logical block may be associated with a unique logical block address (LBA) or sector. Each stream may have a size that is tailored to a storage capacity of one or more physical blocks of the memory device 250. When the controller 230 receives a command such as from the host 300, the controller 230 may read and write data from plural logical blocks associated with plural physical blocks of the memory device 250.

The memory system 210 may include a power supply circuit configured to provide power to at least one component. When operating in a standard or normal mode, the power supply circuit may use power provided by an external device, such as the host 300, to power the one or more components. For example, the power supply circuit can power one or more components using power received from the host 300 via the host interface 220. According to an embodiment, the power supply circuit may include one or more power auxiliary devices configured to power one or more components when operating in a shutdown mode, such as when power input from an external device is interrupted. Examples of power auxiliary devices may include, but are not limited to, capacitors, supercapacitors, batteries, etc. According to an embodiment, the amount of power that can be stored by the one or more power storage components can correspond to a function of the cost and/or size (e.g., area/volume) of the one or more power storage components. As the amount of power stored by the one or more power storage components increases, the cost and/or size of the one or more power storage components can also increase.

The memory system 210 may also include a volatile memory device which the controller 230 may use to temporarily store data or information. The volatile memory device can include one or more volatile memories. For example, the controller 230 may use the volatile memory as a cache. The controller 230 may store cached data or information in the volatile memory until the cached data or information is completely written to the memory device 250. Examples of volatile memory can include, but are not limited to, RAM, DRAM, SRAM, and SDRAM (e.g., double data rate 1 (DDR1), DDR2, DDR3, low voltage double data rate 3 (DDR3L), low power double data rate 3 (LPDDR3), DDR4, LPDDR4, DDR5, LPDDR5, etc.).

Different types of volatile memories may be used with different access properties. For example, DRAM can be arranged for longer burst accesses to allow for improved bandwidth of the same access bus. Alternatively, DRAM may be used with smaller accesses so that random small accesses have better latency. The controller 230 may include additional optional SRAM and/or embedded MRAM. Embedded MRAM is another alternative memory that can be used in other embodiments. Similarly, while access to MRAM may be optimized for various design purposes, the amount of embedded MRAM in the controller 230 could be cost-sensitive. Thus, the choice of how much data and what data goes into premium non-volatile memory and premium volatile memory can be influenced by system tradeoffs.

The controller 230 within the memory system 210 may manage one or more operations of the memory system 210. For example, the controller 230 may include plural pipelines for parallel processing. The controller 230 may include at least one processor or core. Data input/output commands input from the host 300 or commands generated within the controller 230 may be divided into multiple stages or tasks for parallel processing, which may be processed. Plural pipelines may divide command processing into multiple stages or tasks so that at least one core can perform tasks for multiple threads simultaneously. According to an embodiment, the plural pipelines can be configured to perform command processing through a superscalar technique that has multiple cores capable of processing the plural pipelines.

Referring to FIGS. 1 and 2, the memory system 210, 210A, 210B can perform data input/output commands input from the plural hosts 300, 300A, 300B, 300C and store data transmitted from the plural hosts 300, 300A, 300B, 300C. The swap data can be included among the data transmitted from the plural hosts 300, 300A, 300B, 300C.

A processor such as a central processing unit (CPU) in the host machine 310 may be configured to execute commands generated from the application 380, the host operating system 320, and the virtual machine 340, 350 and may process data corresponding to commands or calculation. The host memory 370 can temporarily store a program currently being executed by the central processing unit (CPU) and the corresponding data. The host memory 370 may have (for example, be provided with) a fast data input/output speed, so that it can quickly provide data and commands required by the central processing unit (CPU). When the storage space of the host memory 370 is insufficient, the memory system 210 may operate as a swap memory. The swap operation may virtually expand the storage space of the host memory 370, so that the application 380, the host operating system 320, or the virtual machine 340, 350 can perform a task requiring a high amount of data storage space. However, because the operation speed of the memory system 210 may be slower than that of the host memory 370, the memory system 210 can be configured to reduce degradation of system performance through the swap operation.

Through the swap memory, the host 300 can simultaneously execute more applications 380 and avoid or prevent programs from being forcibly terminated when the memory is insufficient. In addition, the embodiments may prevent the application 380, the host operating system 320, or the virtual machine 340, 350 from crashing due to memory allocation failure, thereby improving the stability of the data processing system.

In addition, according to an embodiment, the swap memory may be used primarily to temporarily store data that is not used for a long time or data with a low priority. By moving data generated or used when the host machine 310 executes a low priority process to the swap area of the memory system 210 instead of the host memory 370, the operating performance of the host 300 could be improved.

In addition, the swap memory can be used when the host 300 performs a memory-intensive task. When performing a task with a large amount of memory usage, such as large-scale database processing, large-capacity file processing, or advanced graphic processing, the swap area of the memory system 210 can assist the host memory 370 so that the host 300 can continue the tasks. Such swap memory can provide more flexibility in memory management of the data processing system and can help optimize the use of the host memory 370 included in the host 300.

The size of the swap area set in the memory system 210 may be determined in response to a request from the host 300. If the swap area is too large or too small, it could cause performance problems or memory shortage problems. According to an embodiment, the size of the swap area in the memory system 210 may be determined in response to the size of the host memory 370. If the swap area is set too large compared to the required space, the amount of unused space in the swap area in the memory system 210 could increase, resulting in wasted storage space. On the other hand, if the swap area is set to be too small compared to the required space, both the host memory 370 and the swap area in the memory system 210 may become full, resulting in a memory shortage, or abnormal termination of the application 380, the host operating system 320, or the virtual machine 340, 350, or stability problems of the host 300. In addition, if the swap area is smaller than the required space, the host 300 and the memory system 210 may frequently perform swap in and swap out operations, which may result in a deterioration in the overall performance of the data processing system.

FIG. 3 illustrates a swap operation according to an embodiment of the present disclosure.

Referring to FIGS. 1 to 3, the swap operation may be initiated by a swap request for specific data (e.g., page). The specific data corresponding to the swap request may be stored in a temporary buffer or cache (e.g., Swap Cache) for the swap operation. According to an embodiment, the swap operation may include a three-stage configuration mechanism of a swap task in a swap cache, a swap task in a front-end (e.g., Front Swap), and a swap task in a back-end (e.g., Swap Area, Swap Backing Store). Herein, the swap task in the front-end (e.g., Front-End) can include an operation of generating or preparing swap data in the host 300, and the swap task in the back-end (e.g., Back-End) may include an operation of storing swap data in the memory system 210.

The swap cache may refer to a case where contents of the swap area temporarily exist in the host memory 370 when the specific data (e.g., page) is swapped out or into the swap area. For example, the specific data (e.g., page) used by a process running in an application 380 of the host 300, a host operating system 320, or a virtual machine 340, 350 can be stored in a swap area due to memory shortage. During this process, the data may remain in the host memory 370.

According to an embodiment, the swap task in the front-end can be performed through a high-speed operation device capable of synchronously storing swap data (e.g., page). For example, the swap task in the front-end can be performed in the virtual machine 340, 350 within the host 300. A transcendent memory (TMEM) within a virtual machine 340, 350 can be a feature provided by a kernel 344, 354 of the operating system 342, 352 (e.g., Linux) that represents a class of memory of unknown and dynamically variable size. The transcendent memory can only be indirectly addressed by the kernel 344, 354, may be persistent or transient (e.g., exists for a short time but could disappear without warning), and may operate fast enough to be accessed synchronously. The transcendent memory can be set up in a DRAM or a persistent memory (PMEM) included in the host memory 370.

While a “swap” feature can be performed through the memory system 210 that the operating system 342, 352 can use to store swapped data (e.g., page), a “zswap” feature may support a function provided by the kernel 344, 354 of the operating system 342, 352 that provides a compressed write-back cache for swapped data (e.g., page) as a form of virtual memory compression. Unlike the “swap” feature in which moves swapped data to the memory system 210 which is a swap device when the swapped data is swapped out, the “zswap” feature can support compression of the swapped data and stores compressed and swapped data in a memory pool (Pool) dynamically allocated to the host memory 370 after compression. Later, a writeback to the actual swap device such as the memory system 210 can be postponed or even completely avoided, so that the input/output (I/O) between the host 300 and the memory system 210, which performs the swap operation, may be significantly reduced.

According to an embodiment, a compressed swap (i.e., zswap) could be performed through crypto compression mechanism (e.g., Crypto Compression) that combines data compression and encryption technology. Examples of algorithms for the crypto compression mechanism (Crypto Compression) can include LZ4, LZO, Snappy, Zstandard, TCOx (e.g., TCO50, TCO30, TCO10, etc.). The crypto compression mechanism may aim to reduce a storage space or a transmission or delivery time of data by identifying and removing duplicates of the data. In addition, the data may be protected through encryption to make the data unreadable by unauthorized parties (e.g., other unauthorized hosts). Compressing and encrypting data simultaneously could be more efficient than separately performing each of processes for compressing and encrypting the data.

According to an embodiment, the compressed swap (i.e., zswap) could be performed via compressed pool (i.e., ZPOOL) or ZFS (i.e., Zettabyte File System) compression. Here, a pool is a logical device group that describes the layout and physical characteristics of available storage. For example, a disk space of a data set can be allocated from a pool. ZFS compression, which is a function that compresses data on the fly, may improve storage efficiency and read performance. Examples of algorithms for the ZFS compression can include ZSMALLOC, ZBUD, Z3FLOLD, and etc. For example, the compressed swap may be implemented from the ZPOOL (stored in PMEM) to a compressed memory storage based on an algorithm such as ZSMALLOC, ZBUD, Z3FLOLD.

The compressed swap (i.e., zswap) may operate like a compressed RAM cache and may operate with uncompressed swap devices. Because the compressed swap (i.e., zswap) stores data in compressed form in host memory 370, the compressed swap (i.e., zswap) may be able to reduce the number of times required for writing and reading, thereby improving the efficiency of swap operations. In addition, the compressed swap (i.e., zswap) may be able to reduce the number of times required for writing data to, and reading data from, a non-volatile memory in the memory system 210, thereby reducing wear and improving lifespan. In addition, the compressed swap (i.e., zswap) can be an abstraction mechanism that can be integrated through the kernel 344, 354 on the operating system 342, 352 using an interface (e.g., API) provided by the front-end. As a result, the compressed swap (i.e., zswap) can have the effect of providing additional storage space to the host memory 370.

According to an embodiment, the swap operation performed in the back-end may be performed through a swap area of the memory system 210. The host 300 may recognize the swap area of the memory system 210 for storing swap data (e.g., Swap entry) as a swap backing store. The swap area of the memory system 210 may be logically or physically separated from the area for storing data in the memory device 250 within the memory system 210.

A swap area corresponding to a swap backing store may be set up by specifying a swap file (for example, swap file1, swap file2) and a swap disk (e.g., Swap Disk/Partition). In addition, according to an embodiment, the swap area corresponding to the swap backing store could be set up using a network file system (NFS) using a storage device (remote server) connected through a network (e.g., Swap over NFS) (e.g., swap file2 may be stored in a remote server partition/dev/hdc1). In order to set up the swap area or the swap backing store through a swap file, a swap disk (e.g., Swap Disk/Partition), and a network file system (NFS), plural tasks such as partitioning a disk (e.g., /dev/sda1, /dev/sda2), setting a swap area (e.g., /dev/zram0), and creating a swap file (e.g., /mnt/swap) may be performed.

Referring to FIGS. 1 to 3, for data swapped out from the swap and zswap operations to the memory system 210, the host 300 can have no way to ensure the integrity of data stored in the swap area of the memory system 210 until the data is swapped into the host memory 370. If the swap data is encrypted and secured, the data could be decrypted and checked for integrity after being swapped out and then swapped in. However, if the swap data is not encrypted and secured, it may be difficult for the host 300 to check the integrity of the swapped in data.

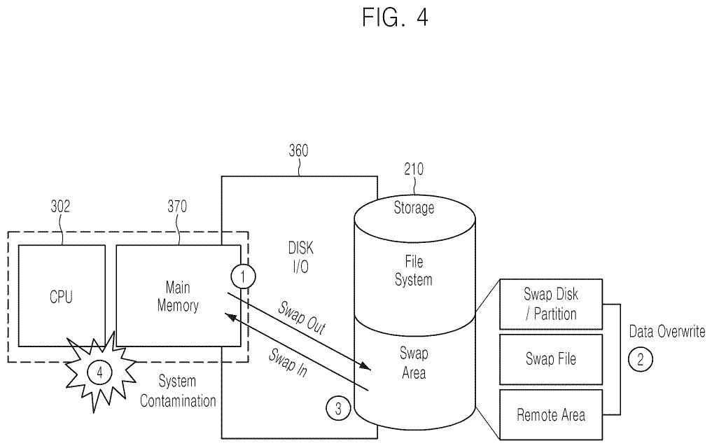

FIG. 4 illustrates a swap operation of a data processing system according to an embodiment of the present disclosure. Specifically, FIG. 4 describes a case where overwriting is performed on swap data that is a target of the swap operation.

Referring to FIG. 4, a host central processing unit (CPU) 302 may swap some of the data stored in the host memory (e.g., main memory) 370. Swapping can be broadly divided into two operations: a ‘swap out’ operation and a ‘swap in’ operation. The ‘swap in’ operation is always performed after the ‘swap out’ operation is performed (in proper functioning instances). A case where the ‘swap in’ operation is performed without the ‘swap out’ operation could be considered a malfunction.

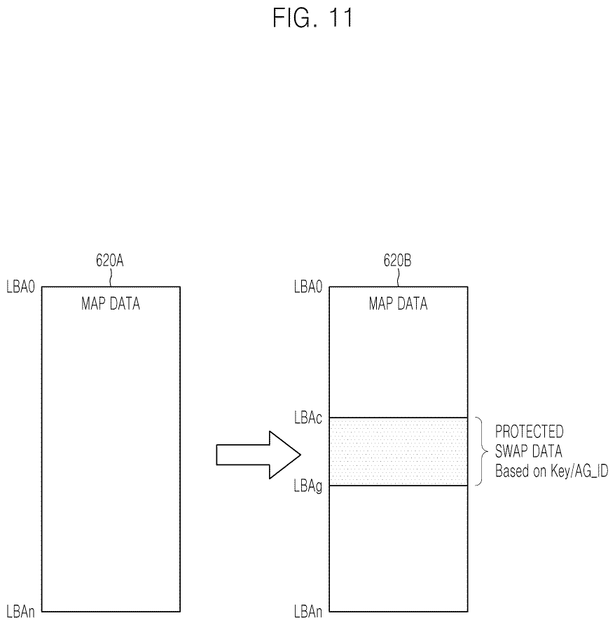

The ‘swap out’ operation may include an operation of moving and processing data from the host memory 370 to the memory system 210. The ‘swap in’ operation may include an operation of transferring and processing data from the memory system 210 to the host memory 370. Data subject to the swapping can include signatures and security keys (e.g., Key/AG_ID, see FIG. 11) for data compression or authentication as described in FIG. 3. The memory system 210 can include a swap area configured to store data subject to the swapping and a file system area configured to store data unrelated to the swapping.

For example, the host central processing unit 302 can immediately detect whether data is contaminated when accessing the data through a memory management unit (MMU) in the data movement within the host memory 370, and can ensure security by responding to unauthorized data access. However, the memory system (e.g., storage) 210 is an external device that performs communication through the input/output controller 360. Because an external input/output device is processed asynchronously, real-time monitoring may be limited. Even if data contamination occurs, the external input/output device may be detected later during a process of checking the data. In particular, in a case of remote storage where the swap area is connected to a network, etc., management may be more difficult.

For example, some of the data (e.g., swap data) stored in the host memory 370 may be stored in the swap area (i.e., Swap Area) in the memory system 210 through the ‘swap out’ operation (\textcircled{1}). The memory system 210 may maintain and manage the data stored in the swap area (i.e., Swap Area). The swap area (i.e., Swap Area) may be set to a remote area (i.e., Remote Area) such as a swap file (e.g., Swap File), a swap disk (e.g., Swap Disk/Partition), or a network file system (NFS). The memory system 210 can be connected to plural hosts 300A, 300B, 300C as described in FIG. 1. If a swap area set in the memory system 210 is shared by the plural hosts 300A, 300B, 300C, there is a possibility that data can be overwritten (\textcircled{2}).

When the host central processing unit 302 requests swap data, data stored in the swap area in the memory system 210 could be moved to the host memory 370 through the ‘swap in’ operation (\textcircled{3}). The host central processing unit 302 may check the swap data stored in the host memory 370 and determine whether the swap data is corrupted (e.g., contaminated) (\textcircled{4}).

As described above, if any data in the Swap Area is changed or modified due to external factors or unexpected factors after the swap data is stored in the memory system 210 through the ‘swap out’ operation, it may be difficult for the host central processing unit 302 to immediately recognize whether the change or modification has occurred. If the host central processing unit 302 does not recognize the change or modification, the contaminated data could be confirmed through following operations after the ‘swap in’ operation. In this procedure, malfunctions and hacking due to data contamination could occur and, consequently, security-related risks might occur in the data processing system.

Referring to FIGS. 1 to 4, there is a difference in a method and a timing of security monitoring and security risk recognition for data stored in the swap area in the host memory 370 and the memory system 210, which is an input/output (I/O) device. Data monitoring for the host memory 370 is performed in real time, so that the host 300 can detect access to the host memory 370. For example, the host 300 may detect immediate access to the host memory 370 through an access bit of the page table entry (PTE). A page table is a data structure that the operating system uses to track the mapping between the virtual address used by the process and the corresponding physical address in the system memory. The page table entry (PTE) is an entry included in the page table that stores information about a specific memory page. Each page table entry (PTE) can include information such as the physical address of the page stored in the host memory 370, whether the page is in the host memory 370, whether the page is writable, or other access rights for the page. In addition, the page table may be managed by the operating system and be accessed and read by the memory management unit (MMU). The host 300 could immediately detect whether the access rights to the page in the host memory 370 have been violated through the memory management unit (MMU).

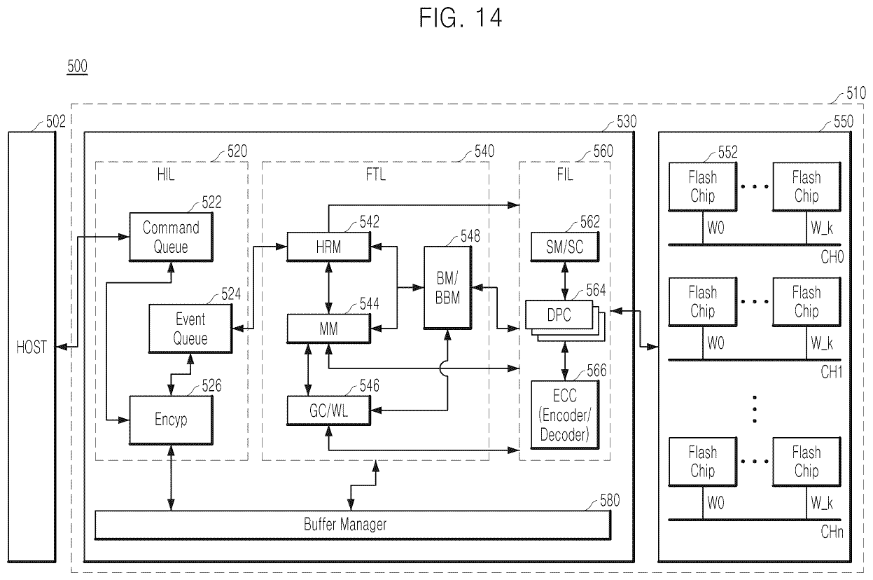

According to an embodiment, the host 300 may track access to the host memory 370 in real time through kernel monitoring tools such as debugging mechanisms (e.g., KProbes, uprobes, etc.). In addition, the host 300 may detect data tampering with the host memory 370, detect immediate tampering attempts through a write protection, track changes to the host memory 370 using resource management techniques (e.g., Copy-on-Write (CoW), etc.), or immediately detect abnormal changes (e.g., errors, etc.) that occur in the host memory 370 through an ECC module (566, see FIG. 14).

On the other hand, data monitoring for the swap area in the memory system 210, which is an input/output (I/O) device, can be different from the host memory 370. It may be difficult for the host 300 to detect real-time access to the swap area in the memory system 210. Because the host 300 may access the memory system 210 through the input/output controller 360, there is a delay in detecting access to the swap area. Although changes to the swap area in the memory system 210 can be tracked through a block layer IO tracing mechanism (e.g., blktrace) that provides detailed information on request queue manipulation up to the user queue, overheads could be large. Therefore, a protective measure configured to prevent abnormal changes to the swap area in the memory system 210 and a supplementary measure configured to handle a case where data is corrupted may be introduced in the data processing system.

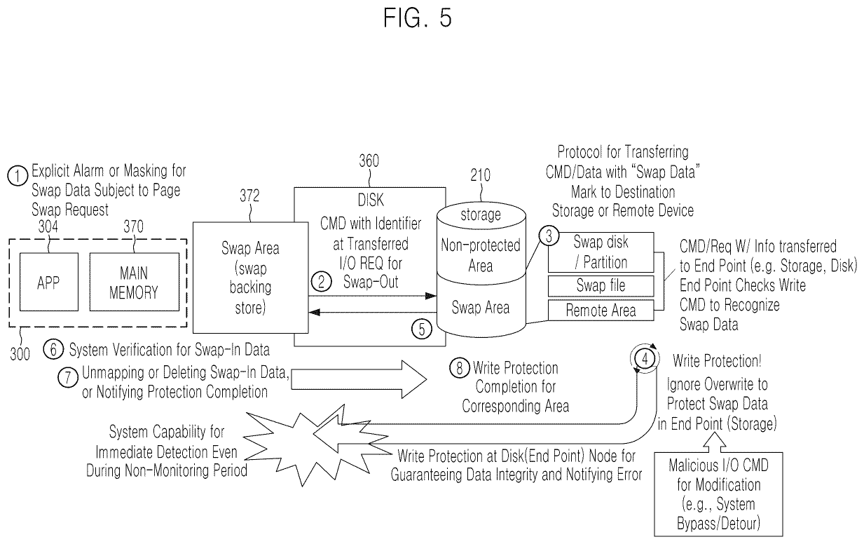

FIG. 5 illustrates a method for protecting swap data according to an embodiment of the present disclosure. Specifically, FIG. 5 describes a mechanism or an operation method for avoiding or preventing the risk described in FIG. 4.

Referring to FIG. 5, the application 304 may store data in the host memory 370 and swap some data of the host memory 370 to the swap area of the memory system 210. The data processing system may include a device and mechanism capable of protecting data within the memory system 210 where the data is stored in order to prevent or avoid contamination of the data stored through the swap operation. When the host 300 informs the memory system 210 that transferred or stored data is swap data, the access of an external device to the swap area where the corresponding data stored within the memory system 210 is being swapped out can be restricted to ensure data integrity. Even if the host 300 does not monitor the swap area of the memory system 210, an operation method performed to ensure data integrity of the swap data in the data processing system is described.

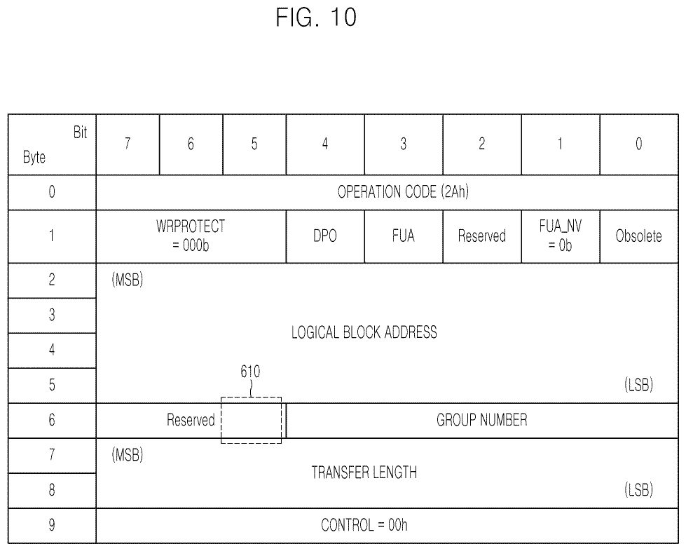

First, when the host 300 requests a swap operation for a page PAGE in the host memory 370, the corresponding swap backing store 372 can be notified or displayed that transferred or stored data is swap data (\textcircled{1}) (for example, based on an explicit alarm or masking for swap data subject to a page swap request). An identifier or the like may be used to indicate a command CMD for an input/output request (e.g., I/O REQ) for the ‘swap out’ operation of the swap data (\textcircled{2}). The memory system 210 may recognize that data transmitted with the corresponding command CMD is the swap data through an identifier or the like included in the command CMD (\textcircled{3}). According to a protocol according to an embodiment of the present disclosure, even when the command CMD and data are transmitted through a remote device connected through a network or through plural stages as well as the memory system 210, an identifier, etc., can be transmitted so that a final target device where the data is stored can recognize that the data is the swap data. The protocol and the command CMD according to an embodiment of the present disclosure will be described later with reference to FIG. 10.

In order to store the swap data in the swap area of the memory system 210, the memory system 210 may check the command CMD. If recognizing that the transmitted data is swap data through an identifier, etc., the memory system 210 may perform write protection on the data (\textcircled{4}). According to an embodiment, the memory system 210 does not avoid overwriting for data stored in a non-protected area other than swap data, but might block overwriting for the swap data stored in the swap area (\textcircled{4}). If the memory system 210 receives an abnormal request (e.g., overwriting, etc.) for the swap data in the swap area, the memory system 210 can determine whether the request might harm the data integrity of the swap data and notify determination to the host 300 (\textcircled{4}). It may be difficult for the host 300 to detect the swap area in the memory system 210 in real time. However, by notifying the host 300 of an error or abnormal request (e.g., overwrite, etc.) from the memory system 210, the embodiments may provide the capability for the host 300 to monitor the swap area within the memory system 210. This may provide write protection at the memory system (e.g., end point) for guaranteeing data integrity and notifying an error. The memory system 210 may thereby implement a capability for immediate detection even during a non-monitoring period.

The host 300 may request the memory system 210 to swap in the swap data, and the memory system 210 can transfer the requested data to the host 300 (\textcircled{5}). The host 300 may perform verification on the swapped-in data through the swap backing store 372, and the verified data (e.g., Data Verified) can be transferred to the host memory 370 (\textcircled{6}).

The host 300 can instruct the memory system 210 to unmap or delete the swapped-in data. In addition, the host 300 can explicitly transmit an additional measure (e.g., Other Protection) related to the corresponding data to the memory system 210 (\textcircled{7}) (for example, unmapping or deleting swap-in data, or notifying protection completion). The memory system 210 may receive the additional measure of the host 300 and perform a security measure such as write protection of the corresponding area (\textcircled{8}).

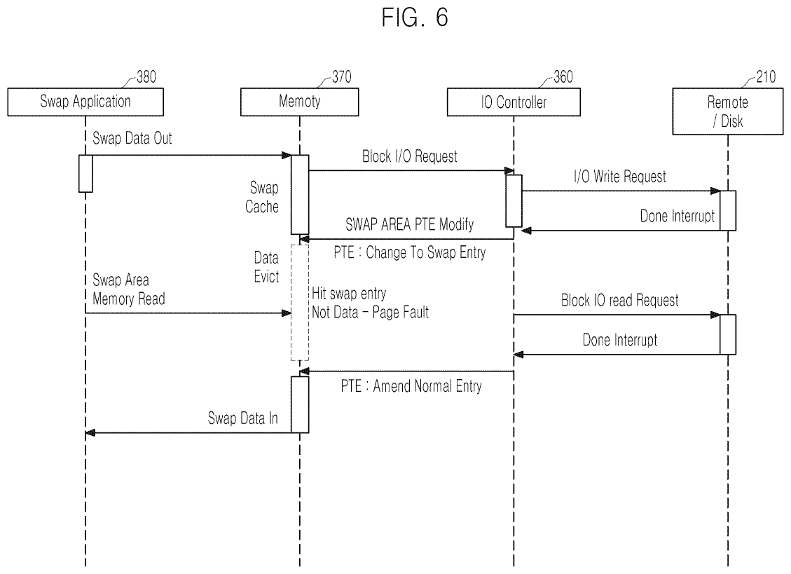

FIG. 6 illustrates an operation method of a data processing system according to an embodiment of the present disclosure. Specifically, FIG. 6 describes a swap operation performed in the data processing system.

Referring to FIG. 6, the swap application 380 may decide to swap out swap data (SWAP DATA) and transmit the swap data to the host memory 370.

The host memory 370 may store the swap data (SWAP DATA) in the swap cache and then transmit a data input/output request (e.g., Block I/O Request) to the input/output controller 360.

The input/output controller 360 may transmit a write request (e.g., I/O Write Request), which is a kind of data input/output command, to the memory system 210 in response to a request transmitted from the host memory 370. The memory system 210 may store data in response to the write request (e.g., I/O Write Request) and then notify completion (e.g., Done Interrupt) of the write request (e.g., I/O Write Request) to the input/output controller 360.

The input/output controller 360 may modify a page table entry for a swap area (e.g., Swap Area PTE Modify), which is information about the swap data (Swap Data), in the host memory 370 based on the completion (e.g., Done Interrupt) of the memory system 210. For example, the page table entry PTE for the swap data (Swap Data) can be changed to a swap entry (e.g., PTE: Change To Swap Entry). The operation procedure up to this point may correspond to a specific operation for the ‘swap out’ operation (Swap Out) during the swap operation.

The swap application 380 can request a read for the swap data (e.g., Swap Area Memory Read). Because the host memory 370 has swapped out the corresponding data to the memory system 210, the corresponding data may not exist in the host memory 370 (e.g., Data Evict) (for example, the host memory 370 may check and notify swap data (e.g., Hit Swap Entry) when the swap data does not exist (e.g., NOT DATA-Page Fault). In response to application's request, the input/output controller 360 can transmit a read request (e.g., Block I/O Read Request), which is a data input/output command, to the memory system 210. The memory system 210 can transmit the data, which has been stored, in response to the read request (e.g., Block I/O Rrite Request) to the input/output controller 360 (e.g., Done Interrupt). The input/output controller 360 may transmit the corresponding data to the host memory 370 and modify the page table entry PTE for the corresponding data to a normal entry (PTE: Amend Normal Entry). The host memory 370 may transmit the corresponding data to the swap application 380 (Swap Data In) based on the page table entry PTE to complete the ‘swap in’ operation.

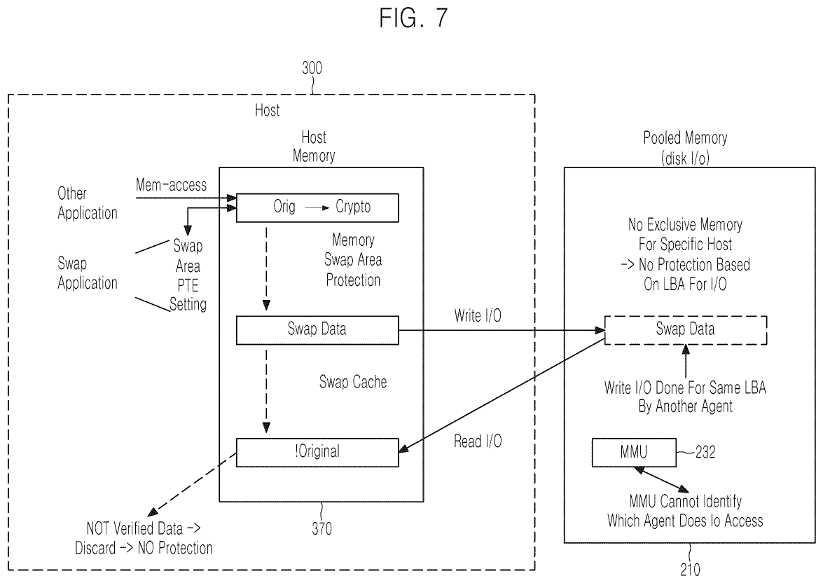

FIG. 7 illustrates a data processing system in which swap data is not protected. Specifically, FIG. 7 describes a case in which data can be contaminated even if the data has been encrypted and swapped out.

Referring to FIG. 7, a swap application (Swap Application) in the host 300 can set at least one of data (ORIG) stored in the host memory 370 as a swap area page table entry (e.g., Swap Area PTE Setting).

If the data (ORIG) is set or designated as the swap area page table entry (e.g., Swap Area PTE Setting), the corresponding data can be protected in the host memory 370 (e.g., Memory Swap Area Protection). Even if an application other than the swap application (e.g., Other Application) accesses the corresponding data in the host memory 370 (e.g., MEM Access), the host memory 370 may detect an abnormal access. According to an embodiment, the corresponding data (ORIG) in the host memory 370 can be encrypted (e.g., Crypto). The corresponding data (ORIG) in the host memory 370 may be transferred to the memory system 210 as swap data along with a write I/O command. The memory system 210 may store the corresponding data. However, the memory system 210 could be shared by plural external devices or plural hosts (e.g., Pooled Memory).

When the memory system 210 is not a dedicated device used for a specific host, transferred swap data might not be protected based on the logical address (e.g., LBA) used for data input/output (I/O) operations. This indicates that a write I/O request for a same logical address (e.g., Same LBA) could be delivered and performed from another external device (e.g., Another Agent) or another host which is connected to the memory system 210.

A memory management unit (e.g., MMU) 232 can be included in the memory system 210, but it may be difficult for the memory management unit 232 to determine or specify from which device the access to the corresponding logical address occurs. Therefore, the memory management unit MMU 232 may not stop or head off a write request for the same logical address. In this case, the swap data in the memory system 210 could be corrupted. For a read request (e.g., Read I/O) of the host 300, the memory system 210 can transmit the swap data corrupted by another external device (e.g., Another Agent) or another host. The corrupted swap data transmitted to the host memory 370 might be different from the swapped out data (ORIG) (e.g., !Original). The corrupted swap data stored in the host memory 370 might not pass verification (e.g., Not Verified Data) and the corresponding data could be discarded (e.g., Discard). In this case, even if the swap data is encrypted (e.g., Crypto), data protection might not be achieved (e.g., NO Protection).

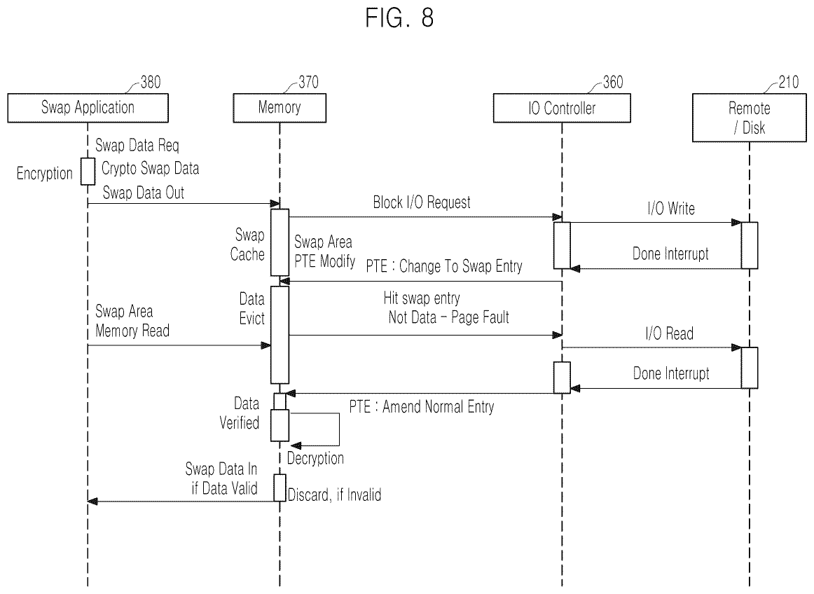

FIG. 8 illustrates an operation method of a data processing system according to an embodiment of the present disclosure. Specifically, FIG. 8 describes events performed between components of the data processing system for performing the swap operation described in FIG. 7.

Referring to FIG. 8, the swap application 380 may generate a request for swap data (e.g., SWAP DATA REQ), determine encryption of swap data to perform encryption (e.g., Crypto SWAP DATA), and transmit a ‘swap out’ request for the swap data to the host memory 370 (e.g., SWAP DATA Out).

The host memory 370 may store the swap data in the swap cache (e.g., Swap Cache), and then transmit a data input/output request (e.g., Block I/O Request) to the input/output controller 360.

The input/output controller 360 may transmit a data input/output command, e.g., a write request (e.g., I/O Write Request), to the memory system 210 in response to a request transmitted from the host memory 370.

The memory system 210 may store data in response to the write request (e.g., I/O Write Request) and then notify completion (e.g., Done Interrupt) of the write request (e.g., I/O Write Request) to the input/output controller 360.

The input/output controller 360 may modify a page table entry PTE for a swap area, which is information on swap data, in the host memory 370 (e.g., Swap Area PTE Modify) in response to the completion (e.g., Done Interrupt) of the memory system 210. For example, the page table entry PTE for the swap data can be changed to a swap entry (e.g., PTE: Change to Swap Entry). The operation procedure up to this point can correspond to a specific operation for the ‘swap out’ operation during the swap operation.

The swap application 380 may request a read for the swap data (e.g., Swap Area Memory Read). Because the host memory 370 swapped out the corresponding data to the memory system 210, the corresponding data might not exist in the host memory 370 (e.g., Data Evict). The host memory 370 can check whether there is the swap data (e.g., Hit Swap Entry) and can notify the input/output controller 360 that the corresponding swap data does not exist in the host memory 370 (e.g., NOT DATA-Page Fault). In response, the input/output controller 360 can transmit a read request (i.e., Block I/O Read Request), which is a kind of data I/O command, to the memory system 210.

The memory system 210 may transmit the data stored in response to a read request (i.e., Block I/O Rrite Request) to the input/output controller 360 (e.g., Done Interrupt). The input/output controller 360 may transmit the data to the host memory 370 and modify the page table entry PTE for the data to a normal entry (e.g., PTE: Amend Normal Entry). The host memory 370 can perform verification on the data based on the page table entry PTE and decrypt the verified data (i.e., Data Verified) through a decryption algorithm or device (Decryption).

The host memory 370 may transmit the decrypted data to the swap application 380 to complete the ‘swap in’ operation. If the data is valid (e.g., if DATA Valid), the data could be swapped in and delivered to the swap application 380 (e.g., Swap Data In). However, if the data is invalid (e.g., if Invalid), the data can be discarded (e.g., Discard if Invalid).

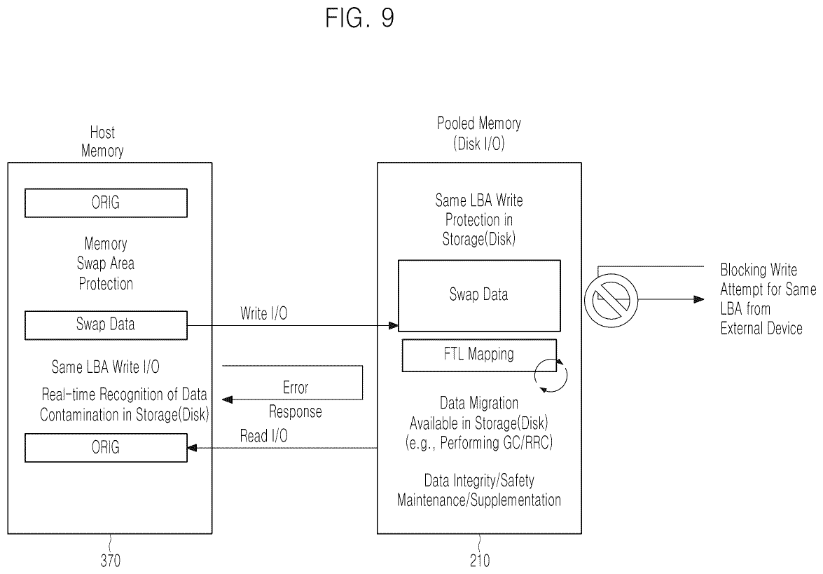

FIG. 9 illustrates an operation method of a memory system according to an embodiment of the present disclosure. Specifically, FIG. 9 describes a method for avoiding or preventing contamination of data described in FIGS. 7 and 8.

Referring to FIG. 9, some of the data stored in the host memory 370, namely swap data (SWAP DATA), can be transferred and stored in the memory system 210. Herein, the memory system 210 may be shared by plural external devices or plural hosts (e.g., Pooled Memory).

If data (ORIG) stored in the host memory 370 is determined to be the swap data (SWAP DATA), the host memory 370 may protect the data (ORIG) with a swap area (e.g., MEMORY SWAP AREA Protection). The swap data (SWAP DATA) can be transmitted to the memory system 210 together with a write command (e.g., Write I/O). The write command (e.g., Write I/O) can include an identifier 610 (see FIG. 10) indicating that the data transmitted together is the swap data (SWAP DATA).

The memory system 210 may recognize the swap data (SWAP DATA) and store the swap data (SWAP DATA) in a memory device. At this time, a controller or a flash translation layer (FTL) 540 (see FIG. 14) within the memory system 210 can generate map data that links a logical address transmitted from a host to a physical address of a memory device (e.g., FTL MAPPING). The controller or the flash translation layer (FTL) within the memory system 210 can record additional information such as an identifier, key, and flag for the swap data (SWAP DATA) in map data 620B (see FIG. 11).

A plurality of external devices or a plurality of hosts operatively engaged with the memory system 210 may transmit a logical address LBA together with a data input/output command. The memory system 210 may find a physical address corresponding to the logical address LBA through the flash translation layer (FTL). In a procedure of finding a physical address corresponding to the logical address LBA based on the map data, the memory system 210 may check whether there is additional information such as an identifier, a key, and a flag for the swap data (SWAP DATA). If there is the additional information, the memory system 210 can restrict, head off, or not perform the corresponding operation. Through this method, the memory system 210 may block a write operation for a same logical address LBA as the swap data (SWAP DATA) (e.g., Write Protection). Even if a write request for the same logical address LBA as the swap data (SWAP DATA) is transmitted from one of the plurality of external devices or the plurality of hosts, the memory system 210 might not perform a write operation corresponding to the corresponding write request. According to an embodiment, the memory system 210 can include an error code in a response corresponding to the corresponding write request and transmit the response to one of the plurality of external devices or the plurality of hosts. Through the host memory 370, real-time recognition of data contamination in the storage disk is possible.

Referring to FIGS. 1 to 9, the swap data (SWAP DATA) does not require an update. The swap data (SWAP DATA) is stored in the memory system 210 due to insufficient storage space in the host memory 370. In many instances, the host 300 may perform the ‘swap in’ operation (SWAP IN) after the ‘swap out’ operation for swapping out the swap data. Meanwhile, another application in the host 300 may transmit the write command (e.g., Write I/O) for the same logical address as the swap data (SWAP DATA). In this case, the memory system 210 may recognize that the corresponding write command (e.g., Write I/O) is an incorrect or unauthorized access based on the map data. At this time, the memory system 210 may transmit the response including an error code (Error Response) to the host 300.

The memory system 210 may output the swap data (SWAP DATA) for the read command (e.g., Read I/O) transmitted from the host 300. Because the memory system 210 did not perform a write operation for the same logical address (LBA) as the swap data (SWAP DATA), the memory system 210 may transmit the original data (ORIG) determined as the swap data (SWAP DATA) based on the read command (e.g., Read I/O).

As described above, the memory system 210 may perform operations corresponding to the read command (e.g., Read I/O) or an unmap or delete command for the same logical address LBA as the swap data (SWAP DATA) stored in the memory device, but head off or block a write operation corresponding to the write command input along with the same logical address LBA. Through this operation method, the memory system 210 can maintain and supplement data security for the swap data (SWAP DATA) requested by the host 300.

According to an embodiment, according to a data security policy, the swap data (SWAP DATA) stored in the memory device within the memory system 210 could be shared by the plurality of external devices or the plurality of hosts. The memory system 210 can check whether the read command (e.g., Read I/O) is input from an external device or a host along with a logical address which is same as the logical address with which the swap data (SWAP DATA) stored by another external device or another host is associated, based on the map data during a procedure of handling or performing a read operation corresponding to the read command (e.g., Read I/O).

Meanwhile, the memory system 210 may perform operations such as garbage collection (GC), read reclaim (RRC), and wear leveling (WL) for the memory device. In this case, a location (i.e., a physical address) of the swap data (SWAP DATA) stored in the memory device might be changed. Even if the swap data (SWAP DATA) is moved or migrated through operations such as the garbage collection (GC), the read reclaim (RRC), and the wear leveling (WL), the memory system 210 can maintain additional information such as an identifier, a key, and a flag in the map data for the logical address corresponding to the swap data (SWAP DATA). Therefore, the memory system 210 may provide the host 300 with uncontaminated swap data (SWAP DATA) without any problem even after performing operations such as the garbage collection (GC), the read reclaim (RRC), and the wear leveling (WL). Through this, the memory system 210 may more flexibly set the swap area for storing the swap data (SWAP DATA), and improve efficiency of resource usage within the memory device.

FIG. 10 illustrates a write command according to an embodiment of the present disclosure. FIG. 10 illustrates a format of the write command (e.g., WRITE command) among SCSI commands as an example. Substantially, a similar format could be applied to other write commands defined in various protocols.

Referring to FIG. 10, the write command can include parameters such as an operation code (e.g., OPERATION CODE, 2Ah), a write protection (e.g., WRPROTECT), a logical address (e.g., LOGICAL BLOCK ADDRESS), a transfer length (e.g., TRANSFER LENGTH), etc.

Specifically, the write command may be used for requesting the host 300 to transmit data stored in a specified or designated logical block (e.g., Logical Block) of a data output buffer and store the corresponding data in the memory system 210 (including a most significant bit (MSB) to a least significant bit (LSB)). Each transmitted logical block can include user data. Protection information could be stored in response to a parameter such as write protection (e.g., WRPROTECT) (and data caching features such as, for example, disable page out (DPO), force unit access (FUA), and obsolete). Each written logical block can include user data. If the stored write protection (e.g., WRPROTECT) is activated, protection information could be additionally added or included in the write command. The transfer length (e.g., TRANSFER LENGTH) may specify the number of consecutive logical data blocks to be transmitted from the data output buffer and be written in the memory system 210, starting from a logical block specified by a start logical address. For example, if the transfer length (e.g., TRANSFER LENGTH) is set to ‘0’, the transfer length (e.g., TRANSFER LENGTH) may indicate that 256 logical blocks are written. For other values, not ‘0’, in the transfer length (e.g., TRANSFER LENGTH), other values could indicate the number of logical blocks to be written in the memory system 210.

There is a spare area (e.g., Reserved) that is included, not used but designated as a reserve, in the write command. In at least one bit 610 of the spare area (e.g., Reserved) designated as the reserve in the write command, additional information such as an identifier, a key, or a flag for the swap data (SWAP DATA) could be included. According to an embodiment, configuration of the additional information may vary depending on an available space in the write command.

FIG. 11 illustrates map data of a memory system according to an embodiment of the present disclosure. Specifically, FIG. 11 describes map data generated and managed by a memory system 210.

Referring to FIG. 11, first map data 620A may include mapping information for logical addresses (e.g., from LBA0 to LBAn). When receiving swap data from the host 300, the memory system 210 may further record additional information such as an identifier, a key, a flag, and an agent number (Key/AG_ID) in the mapping information corresponding to logical addresses (e.g., from LBAc to LBAg) corresponding to the swap data, such as the second map data 620B. The memory system 210 may determine whether to perform an operation for a data input/output request (e.g., a read, write, delete command, etc.) for the logical addresses (from LBAc to LBAg) corresponding to the swap data based on the second map data 620B.

According to an embodiment, the memory system 210 may use a virtual address in response to a logical address used and transmitted by an external device or a host. In this case, the map data can map or link a logical address to a virtual address. In addition, according to an embodiment, configuration of the map data used by the memory system 210 can vary based on internal configuration of the memory device 250.

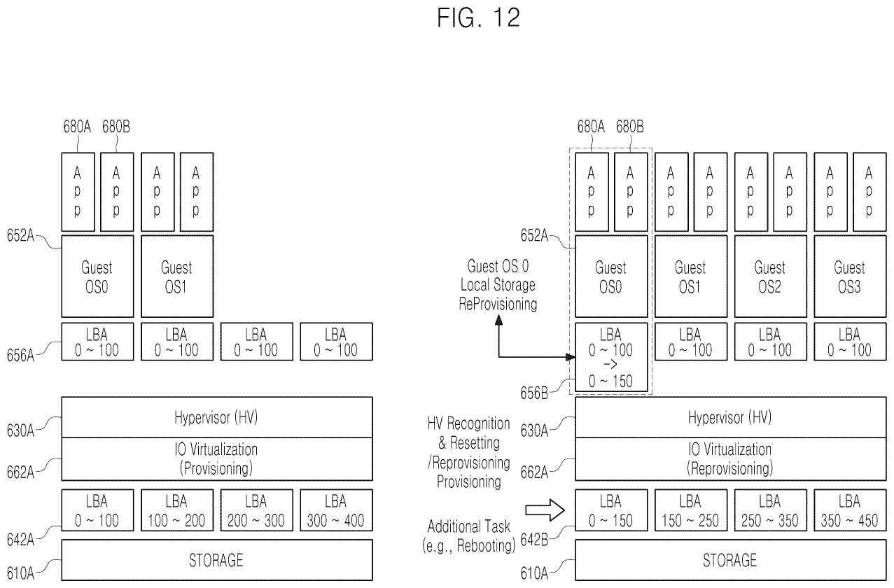

FIG. 12 illustrates a first operation of a shared memory device according to an embodiment of the present disclosure. Specifically, FIG. 12 describes an operation of increasing a storage area size among plural manners or methods for changing the settings of a storage device in a virtualized environment.

Referring to FIG. 12, an application (App) 680A, 680B in a host may recognize a logical address LBA that can be used through an operating system 652A of a virtual machine. The operating system 652A may correspond to the operating system 352 in FIG. 2. A range of logical addresses that can be used may be allocated to plural hosts or plural virtual machines in each host. For convenience of explanation, the operating system (e.g., GS0, GS1) 652A of the virtual machine, which is one of the plural virtual machines in the host, may use logical addresses LBA of ‘0’ and ‘100’. A logical address range of the same size may be allocated to the operating system 652A of each virtual machine.

A hypervisor 630A included in a host may correspond to a hypervisor 330 described in FIG. 2. The operating system 320 within the host 300 described in FIG. 2 may provide input/output (I/O) virtualization provisioning 662A. The input/output virtualization provisioning 662A can include a function of extending and setting the input/output range to enable plural logical partitions (e.g., logical address ranges 656A) to be used simultaneously by the operating systems 652A of the plural virtual machines within the host, which is an external device, to share a storage device 610A. Through the input/output virtualization provisioning 662A, the logical address range (e.g., from ‘0’ to ‘100’) used by the operating systems 652A of each virtual machine can be changed to different logical address ranges 642A (e.g., 0 to 100, 100 to 200, 200 to 300, 300 to 400), so as not to overlap each other. Herein, the storage device 610A may correspond to the memory system 210 described in FIG. 2. The storage device 610A may have sufficient space (or a sufficient storage area) to store data corresponding to an entire logical address range 642B of ‘0’ to ‘400’.

The operating system 652A of the virtual machine, which is one of multiple virtual machines, may request the use of more logical addresses. For example, the operating system 652A of the virtual machine may request a logical address range 656B of ‘0’ to ‘150’ from a logical address range 656A of ‘0’ to ‘100’. This change may imply or indicate that the operating system 652A of the virtual machine can generate and store more data than the operating system 652A used to store.

If the storage device 610A can accommodate it, the entire logical address range 642A of ‘0’ to ‘400’, which can be used to access the storage device 610A through the hypervisor 630A and the input/output (I/O) virtualization provisioning 662A, can be changed and reset to the entire logical address range 642B of ‘0’ to ‘450’. For example, the operations may include hypervisor (HV) recognition and resetting via reprovisioning and/or provisioning. According to an embodiment, additional operations such as rebooting can be required during this procedure for the change or reset.

In addition, according to an embodiment, although FIG. 12 describes a case in which an entire logical address range accessing the storage device 610A is increased, the entire logical address range may be reduced through a similar manner.

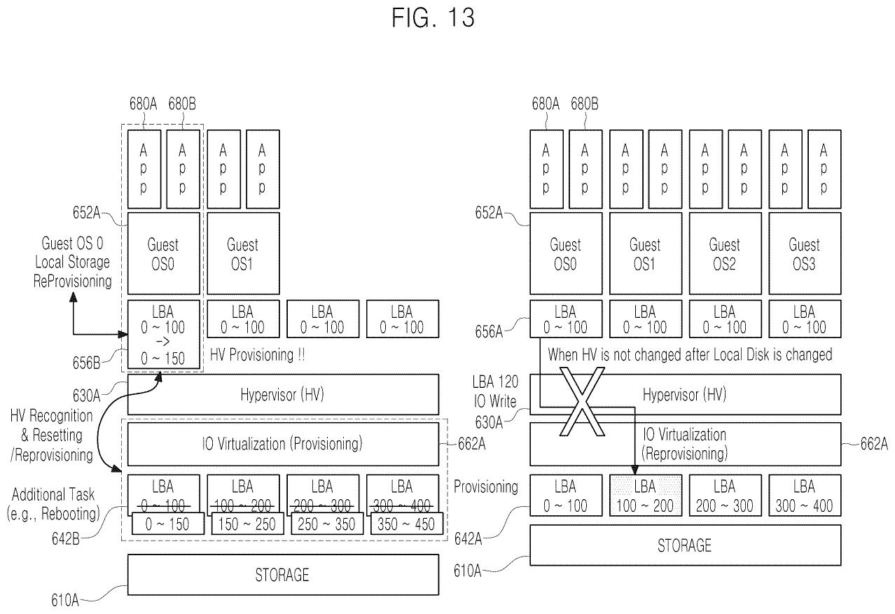

FIG. 13 illustrates a second operation of a shared memory device according to an embodiment of the present disclosure. After increasing the entire logical address range accessing the storage device 610A as described in FIG. 12, FIG. 13 illustrates a case where the entire logical address range is reduced.

Referring to FIG. 12 and FIG. 13, the operating system 652A of the virtual machine requests a logical address range 656B of ‘0’ to ‘150’ from a logical address range 656A of ‘0’ to ‘100’. An entire logical address range 642A of ‘0’ to ‘400’ can be changed and reset to an entire logical address range 642B of ‘0’ to ‘450’ through the hypervisor 630A and the input/output virtualization provisioning 662A.

When the operating system 652A of the virtual machine requests a logical address 656A of ‘0’ and ‘100’ from a logical address 656B of ‘0’ and ‘150’, the logical address range may be reset through the hypervisor 630A and the input/output virtualization provisioning 662A. The entire logical address range 642B of ‘0’ to ‘450’, which can be used to access the storage device 610A, can be changed or reset back to the entire logical address range 642A of ‘0’ to ‘400’ through the hypervisor 630A and the input/output virtualization provisioning 662A.

According to an embodiment, after the logical address range that can access the storage device 610A is changed to ‘0’ to ‘400’, the hypervisor 630A may not reflect the logical address range used by the operating system 652A of the virtual machine. In this case, the hypervisor 630A may determine that the operating system 652A of the virtual machine can use the logical address range of 100 to 150. When the operating system 652A of the virtual machine transmits a write command (e.g., IO Write) for the logical address of 120 (e.g., LBA 120), an incorrect or unauthorized access may occur according to the logical address range 642A of ‘0’ to ‘400’ that has been reset to the storage device 610A. Such incorrect or unauthorized access should be stopped or headed off to prevent or avoid malfunction.

Meanwhile, the operation of reducing the entire logical address range in FIG. 13 can be modified and used for write protection for a specific area of the storage device 610A. For example, when an operating system 652A of the virtual machine requests a logical address range 656A of ‘0’ to ‘100’ from a logical address range 656B of ‘0’ to ‘150’, the hypervisor 630A can notify the operating system 652A of the virtual machine that the setting has been changed to use the logical address range 656A of ‘0’ to ‘100’, but may maintain the entire logical address range 642B of ‘0’ to ‘450’ that can be used to access the storage device 610A through the input/output virtualization provisioning 662A. In this case, the logical address range of ‘100’ to ‘150’ that is used to access the storage device 610A might not be used by the operating systems of the multiple virtual machines, and the operating systems of the plural virtual machines might not generate any data input/output command for the logical address range of ‘100’ to ‘150’ to access the storage device 610A in a normal operation.

Through this circuitous approach, the operating environment of the system may be provided so that other applications cannot generate any data input/output command for logical addresses corresponding to the swap data which any specific application in the host has requested or designated during the swap operation. Even without recording additional information in separate map data in the storage device 610A, the data input/output commands that the host transmits to the memory system could be restricted for the logical addresses corresponding to the swap data that requested for the swap operation. In this way, contamination of the swap data stored in the storage device 610A may be prevented or avoided.

Referring to FIG. 12 and FIG. 13, even if the storage device 610A does not perform a write protection operation based on map data, etc., contamination of the swap data may be avoided or prevented by restricting generation of data input/output commands for the logical addresses of the swap data through the hypervisor 630A that can recognize the swap data or swap data related information.

FIG. 14 illustrates a data processing system 500 according to an embodiment of the present disclosure.

Referring to FIG. 14, the data processing system 500 may include a host 502 engaged or coupled with a memory system 510. For example, the host 502 and the memory system 510 can be coupled to each other via a data bus, a host cable and the like to perform data communication. According to an embodiment, the memory system 510 included in the data processing system 500 may correspond to the memory system 210 shown in FIG. 2.

The memory system 510 may include a memory device 550 and a controller 530. The memory device 550 and the controller 530 in the memory system 510 may be considered components or elements physically separated from each other. The memory device 550 and the controller 530 may be connected via at least one data path. For example, the data path may include a channel and/or a way. According to an embodiment, the memory device 550 can include the memory device 250 shown in FIG. 2.

The memory device 550 may include plural memory chips (e.g., flash chips) 552 coupled to the controller 530 through plural channels CH0, CH1, . . . , CHn and ways W0, . . . , W_k. The memory chip 552 can include a plurality of memory planes or a plurality of memory dies. According to an embodiment, the memory plane may be considered a logical or a physical partition including at least one memory block, a driving circuit capable of controlling an array including a plurality of non-volatile memory cells, and a buffer that can temporarily store data inputted to, or outputted from, non-volatile memory cells. Each memory plane or each memory die can support an interleaving mode in which plural data input/output operations are performed in parallel or simultaneously. According to an embodiment, memory blocks included in each memory plane, or each memory die, included in the memory device 550 can be grouped to input/output plural data entries as a super memory block. An internal configuration of the memory device 550 shown in FIG. 14 may be changed based on operating performance of the memory system 510. An embodiment of the present disclosure may not be limited to the internal configuration described in FIG. 14.

According to an embodiment, the memory device 550 and the controller 530 may be functionally divided into components or elements. Further, according to an embodiment, the memory device 550 and the controller 530 may be implemented with a single chip or a plurality of chips.

The controller 530 may perform a data input/output operation (such as a read operation, a program operation, an erase operation, etc.) in response to a request or a command input from an external device such as the host 502. For example, when the controller 530 performs a read operation in response to a read request input from an external device, data stored in a plurality of non-volatile memory cells included in the memory device 550 is transferred to the controller 530. Further, the controller 530 may independently perform an operation regardless of the request or the command input from the host 502. Regarding an operating state of the memory device 550, the controller 530 may perform an operation such as garbage collection (GC), wear leveling (WL), a bad block management (BBM) for checking whether a memory block is bad and handling a bad block.

Each memory chip 552 can include a plurality of memory blocks. The memory blocks may be understood to be a group of non-volatile memory cells in which data is removed together by a single erase operation. Although not illustrated, the memory block may include a page which is a group of non-volatile memory cells that store data together during a single program operation or output data together during a single read operation. For example, one memory block may include a plurality of pages. The memory device 550 may include a voltage supply circuit capable of supplying at least one voltage into the memory block. The voltage supply circuit may supply a read voltage Vrd, a program voltage Vprog, a pass voltage Vpass, or an erase voltage Vers into a non-volatile memory cell included in the memory block.

The host 502, which interworks with the memory system 510, or the data processing system 500 (including the memory system 510 and the host 502) may be a mobility electronic device (such as a vehicle), a portable electronic device (such as a mobile phone, an MP3 player, a laptop computer, or the like), and a non-portable electronic device (such as a desktop computer, a game machine, a TV, a projector, or the like). The host 502 may provide interaction between the host 502 and a user using the data processing system 500 or the memory system 510 through at least one operating system (OS). The host 502 may transmit a plurality of commands corresponding to a user's request to the memory system 510, and the memory system 510 may perform data input/output operations corresponding to the plurality of commands (e.g., operations corresponding to the user's request). According to an embodiment, the host 502 may correspond to the host 300 shown in FIG. 2.

Referring to FIG. 14, the controller 530 in the memory system 510 can operate along with the host 502 and the memory device 550. As illustrated, the controller 530 may include a layered structure including the host interface layer (HIL) 520, a flash translation layer (FTL) 540, and a flash interface layer (FIL, or a memory interface layer) 560.

The host interface layer (HIL) 520, the flash translation layer (FTL) 540, and the flash interface layer (FIL) 560 are illustrated as one embodiment. The host interface layer (HIL) 520, the flash translation layer (FTL) 540, and the flash interface layer (FIL) 560 may be implemented in various forms according to the operating performance of the memory system 510. According to an embodiment, the host interface layer (HIL) 520, the flash translation layer (FTL) 540, and the flash interface layer (FIL) 560 may perform operations through multi cores or processors having a pipelined structure included in the controller 530.

The host 502 and the memory system 510 may use a predetermined set of rules or procedures for data communication or a preset interface to transmit and receive data therebetween. Examples of sets of rules or procedures for data communication standards or interfaces supported by the host 502 and the memory system 510 for sending and receiving data include Universal Serial Bus (USB), Multi-Media Card (MMC), Parallel Advanced Technology Attachment (PATA), Small Computer System Interface (SCSI), Enhanced Small Disk Interface (ESDI), Integrated Drive Electronics (IDE), Peripheral Component Interconnect Express (PCIe or PCI-e), Serial-attached SCSI (SAS), Serial Advanced Technology Attachment (SATA), Mobile Industry Processor Interface (MIPI), and the like. According to an embodiment, the host 502 and the memory system 510 may be coupled to each other through a Universal Serial Bus (USB). The Universal Serial Bus (USB) is a highly scalable, hot-pluggable, plug-and-play serial interface that ensures cost-effective, standard connectivity to peripheral devices such as keyboards, mice, joysticks, printers, scanners, storage devices, modems, video conferencing cameras, and the like.

The memory system 510 may support the non-volatile memory express (NVMe). The non-volatile memory express (NVMe) is a type of interface based at least on a Peripheral Component Interconnect Express (PCIe) designed to increase performance and design flexibility of the host 502, servers, computing devices, and the like equipped with the non-volatile memory system 510. The PCIe can use a slot or a specific cable for connecting a computing device (e.g., host 502) and a peripheral device (e.g., memory system 510). For example, the PCIe can use a plurality of pins (e.g., 18 pins, 32 pins, 49 pins, or 82 pins) and at least one wire (e.g., x1, x4, x8, or x16) to achieve high speed data communication over several hundred MB per second. According to an embodiment, the PCIe scheme may achieve bandwidths of tens to hundreds of Giga bits per second.

A buffer manager 580 included in the controller 530 can control the input/output of data or operation information in conjunction with the host interface layer (HIL) 520, the flash translation layer (FTL) 540, and the flash interface layer (FIL) 560. To this end, the buffer manager 580 can set or establish various buffers, caches, or queues in a memory, and control data input/output of the buffers, the caches, or the queues, or data transmission between the buffers, the caches, or the queues in response to a request or a command generated by the host interface layer (HIL) 520, the flash translation layer (FTL) 540, and the flash interface layer (FIL) 560. For example, the controller 530 may temporarily store read data provided from the memory device 550 in response to a request from the host 502 before providing the read data to the host 502. Also, the controller 530 may temporarily store write data provided from the host 502 in a memory before storing the write data in the memory device 550. When controlling operations such as a read operation, a program operation, and an erase operation performed within the memory device 550, the read data or the write data transmitted or generated between the controller 530 and the memory device 550 in the memory system 510 could be stored and managed in a buffer, a queue, etc., established in the memory by the buffer manager 580. Besides the read data or the write data, the buffer manager 580 can store signal or information (e.g., map data, a read command, a program command, or etc. which is used for performing operations such as programming and reading data between the host 502 and the memory device 550) in the buffer, the cache, the queue, etc. established in the memory. The buffer manager 580 may set, or manage, a command queue, a program memory, a data memory, a write buffer/cache, a read buffer/cache, a data buffer/cache, a map buffer/cache, etc.

The host interface layer (HIL) 520 may handle commands, data, and the like transmitted from the host 502. By way of example but not limitation, the host interface layer 520 may include a command queue manager 522 and an event queue manager 524. The command queue manager 522 may sequentially store the commands, the data, and the like received from the host 502 in a command queue, and output them to the event queue manager 524, for example, in an order in which they are stored in the command queue manager 522. The event queue manager 524 may sequentially transmit events for processing the commands, the data, and the like received from the command queue. According to an embodiment, the event queue manager 524 may classify, manage, or adjust the commands, the data, and the like received from the command queue. Further, according to an embodiment, the host interface layer 520 may include an encryption manager (Encyp) 526 configured to encrypt a response or output data to be transmitted to the host 502 or to decrypt an encrypted portion in the command or data transmitted from the host 502.

A plurality of commands or data of the same characteristic may be transmitted from the host 502, or a plurality of commands and data of different characteristics may be transmitted to the memory system 510 after being mixed or jumbled by the host 502. For example, a plurality of commands for reading data, i.e., read commands, may be delivered, or commands for reading data, i.e., a read command, and a command for programming/writing data, i.e., a write command, may be alternately transmitted to the memory system 510. The command queue manager 522 of the host interface layer 520 may sequentially store commands, data, and the like, which are transmitted from the host 502, in the command queue. Thereafter, the host interface layer 520 may estimate or predict what type of internal operations the controller 530 will perform according to the characteristics of the commands, the data, and the like, which have been transmitted from the host 502. The host interface layer 520 may determine a processing order and a priority of commands, data and the like based on their characteristics. According to the characteristics of the commands, the data, and the like transmitted from the host 502, the event queue manager 524 in the host interface layer 520 is configured to receive an event, which should be processed or handled internally within the memory system 510 or the controller 530 according to the commands, the data, and the like input from the host 502, from the buffer manager 580. Then, the event queue manager 524 may transfer the event including the commands, the data, and the like into the flash translation layer (FTL) 540.

According to an embodiment, the flash translation layer (FTL) 540 may include a host request manager (HRM) 542, a map manager (MM) 544, a state manager (GL/WL) 546, and a block manager (BM/BBM) 548. Further, according to an embodiment, the flash translation layer (FTL) 540 may implement a multi-thread scheme to perform data input/output (I/O) operations. A multi-thread FTL may be implemented through a multi-core processor using multi-thread included in the controller 530. For example, the host request manager (HRM) 542 may manage the events transmitted from the event queue. The map manager (MM) 544 may handle or control map data. The state manager 546 may perform an operation such as garbage collection (GC) or wear leveling (WL), after checking an operating state of the memory device 550. The block manager 548 may execute commands or instructions onto a block in the memory device 550.

The host request manager (HRM) 542 may use the map manager (MM) 544 and the block manager 548 to handle or process requests according to read and program commands and events which are delivered from the host interface layer 520. The host request manager (HRM) 542 may send an inquiry request to the map manager (MM) 544 to determine a physical address corresponding to a logical address which is entered with the events. The host request manager (HRM) 542 may send a read request with the physical address to the flash interface layer 560 to process the read request, i.e., handle the events. In one embodiment, the host request manager (HRM) 542 may send a program request (or a write request) to the block manager 548 to program data to a specific empty page storing no data in the memory device 550, and then may transmit a map update request corresponding to the program request to the map manager (MM) 544 in order to update an item relevant to the programmed data in information of mapping the logical and physical addresses to each other.

The block manager 548 may convert a program request delivered from the host request manager (HRM) 542, the map manager (MM) 544, and/or the state manager 546 into a flash program request used for the memory device 550, to manage flash blocks in the memory device 550. To maximize or enhance program or write performance of the memory system 510, the block manager 548 may collect program requests and send flash program requests for multiple-plane and one-shot program operations to the flash interface layer 560. In an embodiment, the block manager 548 may send several flash program requests to the flash interface layer 560 to enhance or maximize parallel processing of a multi-channel and multi-directional flash controller.

In an embodiment, the block manager 548 may manage blocks in the memory device 550 according to the number of valid pages, select and erase blocks having no valid pages when a free block is needed and select a block including the least number of valid pages when it is determined that garbage collection is to be performed. The state manager 546 may perform garbage collection to move valid data stored in the selected block to an empty block and erase data stored in the selected block so that the memory device 550 may have enough free blocks (i.e., empty blocks with no data).

When the block manager 548 provides information regarding a block to be erased to the state manager 546, the state manager 546 may check all flash pages of the block to be erased to determine whether each page of the block is valid. For example, to determine validity of each page, the state manager 546 may identify a logical address recorded in an out-of-band (OOB) area of each page. To determine whether each page is valid, the state manager 546 may compare a physical address of the page with a physical address mapped to a logical address obtained from an inquiry request. The state manager 546 may send a program request to the block manager 548 for each valid page. A map table may be updated by the map manager 544 when a program operation is complete.

The map manager 544 may manage map data, e.g., a logical-physical map table. The map manager 544 may process various requests, for example, queries, updates, and the like, which are generated by the host request manager (HRM) 542 or the state manager 546. The map manager 544 may store the entire map table in the memory device 550, e.g., a flash/non-volatile memory, and cache mapping entries according to the storage capacity of the memory. When a map cache miss occurs while processing inquiry or update requests, the map manager 544 may send a read request to the flash interface layer 560 to load a relevant map table stored in the memory device 550. When the number of dirty cache blocks in the map manager 544 exceeds a certain threshold value, a program request may be sent to the block manager 546, so that a clean cache block is made and a dirty map table may be stored in the memory device 550.

When garbage collection is performed, the state manager 546 copies valid page(s) into a free block, and the host request manager (HRM) 542 may program the latest version of the data for the same logical address of the page and concurrently issue an update request. When the state manager 546 requests the map update in a state in which the copying of the valid page(s) is not completed normally, the map manager 544 may not perform the map table update. This is because the map request is issued with old physical information when the state manager 546 requests the map update and a valid page copy is completed later. The map manager 544 may perform a map update operation to ensure accuracy when, or only if, the latest map table still points to the old physical address.

The flash interface layer (FIL) 560 may exchange data, commands, state information, and the like, with a plurality of memory chips 552 in the memory device 550 through a data communication method. According to an embodiment, the flash interface layer 560 may include a status check schedule manager (SM/SC) 562 and a data path manager (DPC) 564. The status check schedule manager 562 can check and determine the operating state regarding the plurality of memory chips 552 coupled to the controller 530, the operating state regarding a plurality of channels CH0, CH1, . . . , CHn and the plurality of ways W0, . . . , W_k, and the like. The transmission and reception of data or commands can be scheduled in response to the operating states regarding the plurality of memory chips 552 and the plurality of channels CH0, CH1, . . . , CHn. The data path manager 564 can control the transmission and reception of data, commands, etc. through the plurality of channels CH0, CH1, . . . , CHn and ways W0, . . . , W_k based on the information transmitted from the status check schedule manager 562. According to an embodiment, the data path manager 564 may include a plurality of transceivers, each transceiver corresponding to each of the plurality of channels CH0, CH1, . . . , CHn. Further, according to an embodiment, the status check schedule manager 562 and the data path manager 564 included in the flash interface layer 560 may be implemented as, or engaged with, a memory control sequence generator.

According to an embodiment, the flash interface layer 560 may further include an ECC (error correction code) circuitry 566 configured to perform error checking and correction of data transferred between the controller 530 and the memory device 550. The ECC circuitry 566 may be implemented as a separate module, circuit, or firmware in the controller 530, but may also be implemented in each memory chip 552 included in the memory device 550 according to an embodiment. The ECC circuitry 566 may include a program, a circuit, a module, a system, or an apparatus for detecting and correcting an error bit of data processed by the memory device 550.

For finding and correcting any error of data transferred from the memory device 550, the ECC circuitry 566 can include an error correction code (ECC) encoder and an ECC decoder. The ECC encoder may perform error correction encoding of data to be programmed in the memory device 550 to generate encoded data into which a parity bit is added and store the encoded data in the memory device 550. The ECC decoder may detect and correct error bits contained in the data read from the memory device 550 when the controller 530 reads the data stored in the memory device 550. For example, after performing error correction decoding on the data read from the memory device 550, the ECC circuitry 566 may determine whether the error correction decoding has succeeded or not, and outputs an instruction signal, e.g., a correction success signal or a correction fail signal, based on a result of the error correction decoding. The ECC circuitry 566 may use a parity bit, which has been generated during the ECC encoding process for the data stored in the memory device 550, to correct the error bits of the read data entries. When the number of the error bits is greater than or equal to the number of correctable error bits, the ECC circuitry 566 may not correct the error bits and instead may output the correction fail signal indicating failure in correcting the error bits.

According to an embodiment, the ECC circuitry 566 may perform an error correction operation based on a coded modulation such as a low density parity check (LDPC) code, a Bose-Chaudhuri-Hocquenghem (BCH) code, a turbo code, a Reed-Solomon (RS) code, a convolution code, a recursive systematic code (RSC), a trellis-coded modulation (TCM), a Block coded modulation (BCM), or the like. The error correction circuitry 566 may include all circuits, modules, systems, and/or devices for performing the error correction operation based on at least one of the above-described codes.

For example, the encoder in the ECC circuitry 566 may generate a codeword that is a unit of ECC-applied data. A codeword of length n bits may include k bits of user data and (n-k) bits of parity. A code rate may be calculated as (k/n). The higher the code rate, the more user data that can be stored in a given codeword. When the length of the codeword is longer and the code rate is smaller, the error correction capability of the ECC circuitry 566 may be improved. In addition, the ECC circuitry 566 performs decoding using information read from the channels CH0, CH1, . . . , CHn. The decoder in the ECC circuitry 566 can be classified into a hard decision decoder and a soft decision decoder according to how many bits represent the information to be decoded. A hard decision decoder performs decoding with a memory cell output information expressed in 1 bit, and the 1-bit information used at this time is called hard decision information. A soft decision decoder uses more accurate memory cell output information composed of 5 bits or more, and this information is called soft decision information. The ECC circuitry 566 may correct errors included in data using the hard decision information or the soft decision information.

According to an embodiment, to increase the error correction capability, the ECC circuitry 566 may use a concatenated code using two or more codes. In addition, the ECC circuitry 566 may use a product code that divides one codeword into several rows and columns and applies a different relatively short ECC to each row and column.

In accordance with an embodiment, a manager included in the host interface layer 520, the flash translation layer (FTL) 540, and the flash interface layer (FIL) 560 could be implemented with a general processor, an accelerator, a dedicated processor, a co-processor, a multi-core processor, or the like. According to an embodiment, the manager can be implemented with firmware working with a processor.

According to an embodiment, the memory device 550 is embodied as a non-volatile memory such as a flash memory, for example, a Read Only Memory (ROM), a Mask ROM (MROM), a Programmable ROM (PROM), an Erasable ROM (EPROM), an Electrically Erasable ROM (EEPROM), a Magnetic RAM (MRAM), a NAND flash memory, a NOR flash memory, or the like. In another embodiment, the memory device 550 may be implemented by at least one of a phase change random access memory (PCRAM), a Resistive Random Access Memory (ReRAM), a ferroelectrics random access memory (FRAM), a spin transfer torque random access memory (STT-RAM), and a spin transfer torque magnetic random access memory (STT-MRAM), or the like.

According to an embodiment, the memory system 510 may support dividing a storage area in which data entries are stored in the memory device 550 based on a preset standard and dedicating each of divided areas to a specific range of logical block addresses (LBA). When supporting zoned namespaces, the memory system 510 can increase access efficiency and reduce an access time by using a logical block address range dedicated for each area rather than using a specific logical block address range that spans multiple areas. For example, zoned namespaces can improve write performance, which can be useful for workloads that require sequential writes of large amounts of data, such as video streaming or data backup.

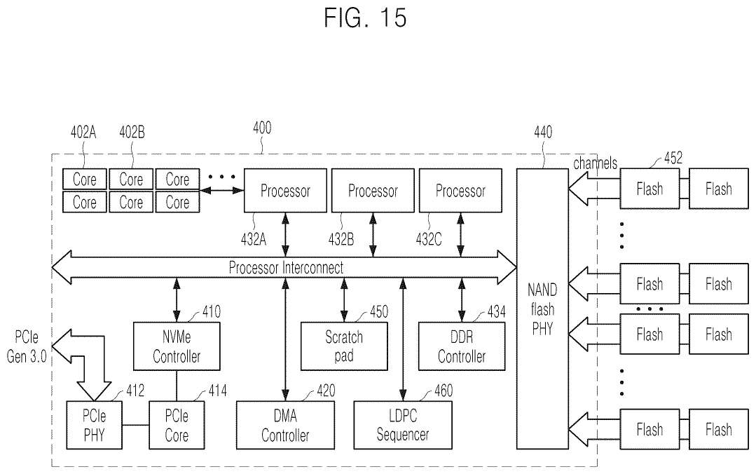

FIG. 15 illustrates a memory system according to an embodiment of the present disclosure. Specifically, FIG. 15 shows a memory system including multiple cores or multiple processors, which is an example of a data storage system. The memory system may support the Non-Volatile Memory Express (NVMe) protocol.

The NVMe is a type of transfer protocol designed for a solid-state memory that could operate much faster than a conventional hard drive. The NVMe can support higher input/output operations per second (IOPS) and lower latency, resulting in faster data transfer speeds and improved overall performance of the data storage system. Unlike SATA which has been designed for a hard drive, the NVMe can leverage the parallelism of solid-state storage to enable more efficient use of multiple queues and processors (e.g., CPUs). The NVMe is designed to allow hosts to use many threads to achieve higher bandwidth. The NVMe can allow the full level of parallelism offered by SSDs to be fully exploited. However, because of limited firmware scalability, limited computational power, and high hardware contention within SSDs, the memory system might not process a large number of I/O requests in parallel.

Referring to FIG. 15, the host, which is an external device, can be coupled to the memory system through a plurality of PCIe Gen 3.0 lanes, a PCIe physical (PHY) layer 412, and a PCIe core 414. A controller 400 may include three embedded processors 432A, 432B, 432C, each using a plurality of cores 402A, 402B. Herein, the plurality of cores 402A, 402B or the plurality of embedded processors 432A, 432B, 432C may have a pipeline structure.

The plurality of embedded processors 432A, 432B, 432C may be coupled to an internal DRAM controller (DDR controller) 434 through a processor interconnect. The controller 400 further includes a Low Density Parity-Check (LDPC) sequencer 460, a Direct Memory Access (DMA) engine (controller) 420, a scratch pad memory 450 for metadata management, and an NVMe controller 410. Components within the controller 400 may be coupled to a plurality of channels connected to a plurality of memory packages (Flash) 452 through a flash physical layer (NAND flash PHY) 440. The plurality of memory packages 452 may correspond to the plurality of memory chips 552 described in FIG. 14.

According to an embodiment, the NVMe controller 410 included in the controller 400 is a type of storage controller designed for use with solid state drives (SSDs) that use an NVMe interface. The NVMe controller 410 may manage data transfer between the SSD and the computer CPU as well as other functions such as error correction, wear leveling, and power management. The NVMe controller 410 may use a simplified, low-overhead protocol to support fast data transfer rates.

According to an embodiment, the scratch pad memory 450 may be a storage area set by the NVMe controller 410 to temporarily store data. The scratch pad memory 450 may be used to store data waiting to be written to the plurality of memory packages 452. The scratch pad memory 450 can also be used, typically with a small amount of Dynamic Random Access Memory (DRAM) or Static Random Access Memory (SRAM), as a buffer to speed up the writing process. When a write command is executed, data may first be written to the scratch pad memory 450 and then transferred to the plurality of memory packages 452 in larger blocks. The scratch pad memory 450 may be used as a temporary memory buffer to help optimize the write performance of the plurality of memory packages 452. The scratch pad memory 450 may serve as intermediate storage of data before the data is written to non-volatile memory cells.

The Direct Memory Access (DMA) engine (e.g., DMA controller) 420 included in the controller 400 is a component that transfers data between the NVMe controller 410 and a host memory in the host system without involving a processor in the host system. The DMA engine 420 can support the NVMe controller 410 to directly read or write data from or to the host memory without intervention of the host's processor. According to an embodiment, the DMA engine 420 may achieve or support high-speed data transfer between a host and an NVMe device, using a DMA descriptor that includes information regarding data transfer such as a buffer address, a transfer length, and other control information.

The LDPC sequencer 460 in the controller 400 is a component that performs error correction on data stored in the plurality of (flash) memory packages 452. Herein, an LDPC code is a type of error correction code commonly used in a NAND flash memory to reduce a bit error rate. The LDPC sequencer 460 may be designed to immediately process encoding and decoding of LDPC codes when reading and writing data from and to the NAND flash memory (for example, the plurality of (flash) memory packages 452). According to an embodiment, the LDPC sequencer 460 may divide data into plural blocks, encode each block using an LDPC code, and store the encoded data in the plurality of memory packages 452. Thereafter, when reading the encoded data from the plurality of memory packages 452, the LDPC sequencer 460 can decode the encoded data based on the LDPC code and correct errors that may have occurred during a write or read operation. The LDPC sequencer 460 may correspond to the ECC circuitry 566 described in FIG. 14.

As above described, in an environment where a memory device or a memory system according to an embodiment of the present disclosure performs data input/output operations in conjunction with a plurality of external devices, data safety could be improved or enhanced through an apparatus and a method capable of safely protecting swap data requested by a specific external device in the memory device or the memory system.

In addition, in a data processing system according to an embodiment of the present disclosure, data safety in a shared or pooled memory device could be improved or enhanced by performing a mechanism that supports operations in which not only the host but also the memory system can protect swap data.

The methods, processes, and/or operations described herein may be performed by code or instructions to be executed by a computer, processor, controller, or other signal processing device. The computer, processor, controller, or other signal processing device may be those described herein or one in addition to the elements described herein. Because the algorithms that form the basis of the methods (or operations of the computer, processor, controller, or other signal processing device) are described in detail, the code or instructions for implementing the operations of the method embodiments, may transform the computer, processor, controller, or other signal processing device into a special-purpose processor for performing the methods herein.

Also, another embodiment may include a computer-readable medium, e.g., a non-transitory computer-readable medium, for storing the code or instructions described above. The computer-readable medium may be a volatile or non-volatile memory or other storage device, which may be removably or fixedly coupled to the computer, processor, controller, or other signal processing device which is to execute the code or instructions for performing the method embodiments or operations of the apparatus embodiments herein.

The controllers, processors, control circuitry, devices, modules, units, multiplexers, logic, interfaces, decoders, drivers, generators and other signal generating and signal processing features of the embodiments disclosed herein may be implemented, for example, in non-transitory logic that may include hardware, software, or both. When implemented at least partially in hardware, the controllers, processors, control circuitry, devices, modules, units, multiplexers, logic, interfaces, decoders, drivers, generators and other signal generating and signal processing features may be, for example, any of a variety of integrated circuits including but not limited to an application-specific integrated circuit, a field-programmable gate array, a combination of logic gates, a system-on-chip, a microprocessor, or another type of processing or control circuit.

When implemented at least partially in software, the controllers, processors, control circuitry, devices, modules, units, multiplexers, logic, interfaces, decoders, drivers, generators and other signal generating and signal processing features may include, for example, a memory or other storage device for storing code or instructions to be executed, for example, by a computer, processor, microprocessor, controller, or other signal processing device.

While the present teachings have been illustrated and described with respect to specific embodiments, it will be apparent to those skilled in the art in light of the present disclosure that various changes and modifications may be made without departing from the spirit and scope of the disclosure as defined in the following claims. Furthermore, the embodiments may be combined to form additional embodiments.

What is claimed is:

1. A memory system, comprising:
a memory device configured to store data input along with a data input and output (input/output) command or read the stored data; and
a controller configured to:
receive the data input/output command from at least one of a plurality of external devices and output a response corresponding to the data input/output command,
store, in the memory device, swap data transmitted from a first external device among the plurality of external devices, and
head off a write operation corresponding to a write command which is input, from a second external device among the plurality of external devices, along with a same logical address as the swap data.

2. The memory system according to claim 1, wherein the controller is configured to receive, from the first external device, a write command with a swap identifier for storing the swap data in the memory device.

3. The memory system according to claim 1, wherein the controller is configured to:
generate a map data entry for a logical address and a physical address or a virtual address of the swap data; and
add, to the map data entry, a protection identifier indicating that data associated with the map data entry belongs to a protected area in the memory device.

4. The memory system according to claim 3, wherein the controller is configured to:
perform a garbage collection or a read reclaim operation on the memory device; and
maintain the protection identifier in the map data entry, after the garbage collection or the read reclaim operation performs the swap data belongs to the protected area and updates the map data entry associated with the swap data.

5. The memory system according to claim 1, wherein the controller is configured to:
include an error code in a response corresponding to a write command input along with the same logical address from the first external device; and
transmit the response to the first external device.

6. The memory system according to claim 1, wherein the controller is configured to transmit the swap data to the first external device when a read command transmitted from the first external device is input along with the same logical address.

7. The memory system according to claim 1, wherein the controller is configured to:
include a restriction code in a response corresponding to the write command input along with the same logical address from the second external device; and
transmit the response to the second external device.

8. The memory system according to claim 1, wherein the controller is configured to delete a map data entry for the swap data based on a swap release command input along with the same logical address from the first external device.

9. The memory system according to claim 1, wherein the controller is configured to:
include an error code in a response corresponding to a swap release command input along with the same logical address from the second external device; and
transmit the response to the second external device.

10. The memory system according to claim 1,
wherein the memory device comprises:
a data storage area configured to store write data transmitted from the plurality of external devices; and
a swap area configured to store the swap data that is distinct from the write data, and
wherein the controller is configured to:
partition the data storage area and the swap area into different logical areas; and
generate different map data for the data storage area and the swap area.

11. The memory system according to claim 1, wherein the memory device comprises a plurality of volatile memory cells or a plurality of nonvolatile memory cells configured to store the swap data.

12. A data processing system, comprising:
at least one host, comprising at least one application and a file system, configured to determine a location where write data generated by the at least one application is stored based on the file system; and
at least one memory system configured to receive swap data from the at least one host, generate a map data entry for the swap data and determine whether to access the swap data based on the map data entry.

13. The data processing system according to claim 12, wherein the map data entry comprises a logical address of the swap data and a protection identifier indicating access authority to the logical address.

14. The data processing system according to claim 13, wherein the protection identifier comprises:
at least one of an identifier indicating whether associated data is the swap data; and
unique information assigned to the at least one host which has the access authority.

15. The data processing system according to claim 12,
wherein the at least one host is configured to be rebooted when a range of logical addresses used by the at least one host is changed, and
wherein the at least one memory system is configured to:
receive a changed range of logical addresses used by the at least one host after reboot of the at least one host; and
apply the changed range to map data including the map data entry.

16. The data processing system according to claim 12, wherein the at least one host is configured to transmit, to the at least one memory system, a write command including a swap identifier set to store the swap data in the at least one memory system.

17. The data processing system according to claim 12, wherein the at least one memory system comprises:
a memory device configured to store data corresponding to a data input and output (input/output) command input from the at least one host or read the stored data; and
a controller configured to receive the data input/output command and output a response to the data input/output command.

18. The data processing system according to claim 17, wherein the controller is configured to:
store, in the memory device, the swap data transmitted from a first host among the at least one host; and
head off a write operation corresponding to a write command when the write command is input, from a second host among the at least one host, along with a same logical address as the swap data.

19. The data processing system according to claim 18, wherein the controller is configured to:
include an error code in a response to a write command input along with the same logical address from the first host; and
transmit the response to the first host.

20. The data processing system according to claim 18, wherein the controller is configured to transmit the swap data to the first host based on a read command transmitted along with the same logical address from the first host.

21. The data processing system according to claim 18, wherein the controller is configured to:
include a restriction code in a response corresponding to a read command input along with the same logical address from the second host; and
transmit the response to the second host.

22. The data processing system according to claim 18, wherein the controller is configured to delete a map data entry for the swap data based on a swap release command input along with the same logical address from the first host.

23. The data processing system according to claim 18, wherein the controller is configured to:
include an error code in a response corresponding to a swap release command input along with the same logical address from the second host; and
transmit the response to the second host.

24. A data processing system, comprising:
at least one host comprising a plurality of virtual machines individually configured to perform data communication with an input and output (input/output) device through different address ranges in a unified logical address scheme; and
at least one memory system, as the input/output device, configured to store swap data transmitted from the at least one host,
wherein the at least one host is configured to set a logical address of the swap data, in the unified logical address scheme, to be unavailable to the plurality of virtual machines.

25. The data processing system according to claim 24, wherein at least one of the plurality of virtual machines executes at least one application configured to generate the swap data or designate write data as the swap data.

26. The data processing system according to claim 24, wherein the at least one memory system comprises a remote storage space coupled to the at least one host via a network.

27. The data processing system according to claim 24, wherein the at least one host is configured to:
add an identifier indicating the swap data to a write command; and
transmit the write command to the at least one memory system.
